(19) United States
(12) Patent Application Publication
(10) Pub. No.: US 2022/0078683 A1
(43) Pub. Date: Mar. 10, 2022

(54) METHOD, NODE AND UE FOR INITIATING HANDOVER

(71) Applicant: TELEFONAKTIEBOLAGET LM ERICSSON (PUBL), Stockholm (SE)

(72) Inventors: Cecilia EKLÖF, TÄBY (SE); Icaro L. J. DA SILVA, Solna (SE); Johan RUNE, LIDINGÖ (SE)

(21) Appl. No.: 17/414,468

(22) PCT Filed: Dec. 20, 2019
(86) PCT No.: PCT/SE2019/051332

§ 371 Date: Jun. 16, 2021

Related U.S. Application Data
(60) Provisional application No. 62/805,330, filed on Feb. 14, 2019.

(51) Int. Cl. H04W 36/00; H04W 36/08

(52) U.S. Cl. CPC H04W 36/00837; H04W 36/08

(57) ABSTRACT

The present disclosure relates to a method performed by a UE for initiating handover of the UE from a source cell to a target cell. The UE selects, based on at least one parameter, a target cell from multiple candidate target cells. Each candidate target cell of the multiple candidate target cells fulfills a handover criterion. The UE initiates handover of the UE from the source cell to the selected target cell.

### TECHNICAL FIELD

The present disclosure relate generally to a User Equipment (UE), a method performed by the UE, a first network node, a method performed by the first network node. More particularly the present disclosure relate to initiating handover of the UE from a source cell to a target cell.

### BACKGROUND

Handover (HO) is an important mobility aspect in communication networks. One purpose of a handover procedure may be described as to ensure that the connection to the UE is maintained when the UE moves from one cell to another cell, e.g. from a source cell to a target cell, or from a first cell to a second cell etc. Handover may also be described as moving the UE's connection from one network node to another network node, e.g. from a first network node to a second network node, from a source node to a target node etc. A handover decision may be taken by the network or the UE, or both. Both Long Term Evolution (LTE) and New Radio (NR) have procedures for handover.

Mobility in RRC_CONNECTED in LTE and NR

Radio Resource Control (RRC) is a protocol used in LTE and NR. A UE may be in a certain RRC state. The RRC state may also be described as a phase or mode that the UE may be in. A UE is in RRC_CONNECTED state when an RRC connection is established. A UE is in RRC_IDLE state when no RRC connection is established.

An RRC_CONNECTED UE in LTE, also called Evolved Universal Terrestrial Radio Access (EUTRA), can be configured by the network to perform measurements and, upon triggering measurement reports the network may send a handover command to the UE. In LTE, the handover command may be comprised in a field called mobilityControlInfo in an RRConnectionReconfiguration message. In NR, the handover command may be comprised in a reconfigurationWithSync field in an RRCReconfiguration message.

These reconfigurations are actually prepared by the target cell upon a request from the source node, and take into account the existing RRC configuration the UE has with source cell, which are provided in the inter-node request. The request may be provided over X2 interface in case of EUTRA-Evolved Packet Core (EUTRA-EPC) or the Xn interface in case of EUTRA-5G Core Network (EUTRA-5GC) or NR.

Among other parameters the reconfiguration provided by target cell contains all information the UE needs to access the target cell, e.g. random access configuration, a new Cell-Radio Network Temporary Identifier (C-RNTI) assigned by the target cell and security parameters enabling the UE to calculate new security keys associated to the target cell so the UE can send a handover complete message on Signalling Radio Bearer 1 (SRB1), encrypted and integrity protected, based on new security keys upon accessing the target cell.

FIG. 1a and FIG. 1b show an example the flow signalling between the UE 101, source node 103a and target node 103b during a handover procedure. FIG. 1b is a continuation of FIG. 1a, i.e. the steps of FIG. 1a are performed before the steps of FIG. 1b. FIG. 1a shows steps 0-8 and FIG. 1b shows steps 9-12. The source node is exemplified with a source gNB, the target node is exemplified with a target gNB. The Access and Mobility Management Function (AMF) 110 and one or more User Plane Functions (UPF(s)) 115 are also shown in FIG. 1a and FIG. 1b. The handover procedure exemplified in FIG. 1a and FIG. 1b comprises at least one of the following steps, which steps may be performed in any suitable order than described below:
User data is conveyed between the UE 101 and the source gNB 103a, and between the source gNB 103a and the UPF(s) 115.
Step 0: Mobility control information is provided by the AMF110 to the source gNB 104a.
Step 1: Measurement control and reports are provided between the UE 101 and the source gNB 103a.
Step 2: The source gNB 103a takes a handover decision.
Step 3: The source gNB 103 sends a handover request message to the target gNB 103b.
Step 4: The target gNB 103b performs admission control.
Step 5: The target gNB 103b sends a handover request acknowledge message to the source gNB 103a.
Step 6: A Uu handover trigger is conveyed between the UE 101 and the source gNB 103a.
Step 7: The source gNB 103a sends a SN status transfer message to the target gNB 103b.
The UE 101 detaches from the old cell and synchronizes to the new cell.
The source gNB 103a delivers buffered and in transit user data to the target gNB 103b.
The source gNB 103a forwards user data to the target gNB 103b.
The target gNB 130b buffers user data from the source gNB 103a.
Step 8: The UE 101 synchronizes to the new cell and completes the RRC handover procedure.
User data is conveyed between the UE 101 and the target gNB 103b, and between the target gNB 103b and the UPF(s) 115.
Step 9: The target gNB 103b sends a path switch request message to the AMF 110.
Step 10: Path switch related 5GC internal signaling takes place between the AMF 110 and the UPF(s) 115, and an actual Downlink (DL) path switch in the UPF(s) 115. The AMF 110 may send an end marker to the source gNB 103a.
The end marker is transmitted from the source gNB 103a to the target gNB 103b.
User data is conveyed between the target gNB 103b and the UPF(s) 115.
Step 11: The AMF 110 sends a path switch request acknowledgment to the target gNB 103b.
Step 12: The target gNB 103b sends a UE context release message to the source gNB 103a.

Steps 0-5 are comprised in the handover preparation phase, steps 6-8 are comprised in the handover execution phase and steps 9-12 are comprised in the handover completion phase.

Both in LTE and NR, some principles exist for mobility in RRC_CONNECTED, e.g. for handover:
Mobility in RRC_CONNECTED is network based as the network has best information regarding the current situation such as load conditions, resources in different nodes, available frequencies, etc. For a resource allocation perspective, the network can also take into account the situation of many UEs 101 in the network.
The network prepares a target cell before the UE 101 accesses that cell. The source cell provides the UE 101 with the RRC configuration to be used in the target cell, including the SRB1 configuration to send the HO complete message.
The UE 101 is provided by the target cell with a target C-RNTI i.e. the target cell identifies the UE 101 from Message 3 (MSG.3) on the Medium Access Control (MAC) level for the HO complete message. Hence, there is no context fetching, unless a failure occurs.
To speed up the handover, the network provides needed information on how to access the target cell, e.g. Random Access Channel (RACH) configuration, so the UE 101 does not have to acquire the System Information (SI) prior to the handover.
The UE 101 may be provided with Contention Free Random Access (CFRA) resources, i.e. in the case the target cell identifies the UE from the preamble, e.g. Message 1 (MSG.1). The principle behind this is that the procedure can always be optimized with dedicated resources. This might be a bit tricky in Conditional Handover (CHO) as there is uncertainty about the final target cell, but also about the timing.
Security is prepared before the UE 101 accesses the target cell, i.e. keys must be refreshed before sending the RRC Connection Reconfiguration Complete message, based on new keys and encrypted and integrity protected so the UE 101 can be verified in the target cell.
Both full and delta reconfigurations are supported so that the HO command can be minimized.

Mobility Robustness Work Item in Rel-16 for LTE and NR and Conditional HO

Two new work items for mobility enhancements in LTE and NR have started in Third Generation Partnership Project (3GPP) in release 16 (Rel-16). The main objectives of the work items are to improve the robustness at handover and to decrease the interruption time at handover.

One problem related to robustness at handover is that the HO Command is normally sent when the radio conditions for the UE 101 are already quite bad. This may lead to that the HO Command may not reach the UE 101 in time if the message is segmented or if there are retransmissions. The HO command referred to here is the RRCConnectionReconfiguration message with a mobilityControlInfo and the RRCReconfiguration message with a reconfigurationWithSync field.

In LTE and NR, different solutions to increase mobility robustness have been discussed in the past. One solution discussed in NR is called “conditional handover” or “early handover command”. In order to avoid the undesired dependence on the serving radio link upon the time and radio conditions where the UE 101 should execute the handover, the possibility to provide RRC signaling for the handover to the UE 101 earlier should be provided. To achieve this, it should be possible to associate the HO command with a condition e.g. based on radio conditions possibly similar to the ones associated to an A3 event, where a given neighbour becomes X decibel (dB) better than the target. As soon as the condition is fulfilled, the UE 101 executes the handover in accordance with the provided handover command.

Such a condition could e.g. be that the quality of the target cell or beam becomes X dB stronger than the serving cell. The threshold Y used in a preceding measurement reporting event should then be chosen lower than the one in the handover execution condition. This allows the serving cell to prepare the handover upon reception of an early measurement report and to provide the RRCConnectionReconfiguration with the mobilityControlInfo parameter at a time when the radio link between the source cell and the UE 101 is still stable. The execution of the handover is done at a later point in time and threshold which is considered optimal for the handover execution.

FIG. 2 depicts a signalling diagram involving a serving cell and a target cell during a conditional handover execution. In practice there may often be many cells or beams that the UE 101 reported as possible candidates based on its preceding Radio Resource Management (RRM) measurements. The network should then have the freedom to issue conditional handover commands for several of those candidates. The RRCConnectionReconfiguration for each of those candidates may differ e.g. in terms of the HO execution condition (RS to measure and threshold to exceed) as well as in terms of the Random Access (RA) preamble to be sent when a condition is met.

While the UE 101 evaluates the condition, it should continue operating per its current RRC configuration, i.e., without applying the conditional HO command. When the UE 101 determines that the condition is fulfilled, it disconnects from the serving cell, applies the conditional HO command and connects to the target cell. These steps are equivalent to the current, instantaneous handover execution.

The method shown in FIG. 2 comprises at least one of the following steps, which steps may be performed in any suitable order than described below:
The serving node sends User Plane (UP) data to the UE 101.
Step 1: The UE 101 sends a measurement report to the serving node 103a indicating a “low” threshold.
The serving node 103a takes a HO decision based on an early report.
Step 2: The serving node 103a sends an early HO request message to the target node 103b.
The target node 103b accepts the HO and builds a RRC configuration.
Step 3: The target node 103b sends a HO acknowledgement message to the serving node 103a. The message includes the RRC configuration.
Step 4: The serving node 103a sends a conditional HO command to the UE 101 including a “high” threshold.
When the measurements fulfill the HO condition, then the UE 101 triggers the pending conditional HO.
Step 5: The UE 101 sends a synchronization and random access message to the target node 103b.
Step 6: The UE 101 sends a HO confirmation message to the target node 103b.
Step 7: The target node 103b sends a HO complete message to the serving node 103a.
Step 8: The target node 103b sends UP data to the UE 101.

Selection of Target Cell

It has been decided in RAN2 that multiple cells can be configured as possible target cells for conditional handover. This means that there may be several target cells fulfilling the condition at the same time. The UE 101 needs to make a decision for selecting the target cells in case multiple cells fulfil the conditions configured by the network.

There may be different ways of prioritizing cells at conditional handover. Using prioritization, the UE 101 can choose the target cell based on which cell has the highest priority in case multiple cells fulfil the condition for conditional handover.

Cell Selection and Reselection

The procedures for how the UE 101 chooses cell in RRC_IDLE and RRC_INACTIVE mode are referred to as cell selection and cell reselection. Below is an extract from 3GPP TS 38.304 V15.2.0 (2018-12) related to NR, but similar procedures exist in 3GPP TS 36.304 V15.2.0 (2018-12) related to LTE.

Cell Selection Process

Cell selection is performed by one of the following two procedures:
1) Initial cell selection (no prior knowledge of which Radio Frequency (RF) channels are NR frequencies):
   a. The UE 101 shall scan all RF channels in the NR bands according to its capabilities to find a suitable cell.
   b. On each frequency, the UE 101 need only search for the strongest cell.
   c. Once a suitable cell is found, this cell shall be selected.
2) Cell selection by leveraging stored information:
   a. This procedure requires stored information of frequencies and optionally also information on cell parameters from previously received measurement control information elements or from previously detected cells.
   b. Once the UE 101 has found a suitable cell, the UE 101 shall select it.
   c. If no suitable cell is found, the initial cell selection procedure in a) shall be started.

Priorities between different frequencies or Radio Access Technologies (RAT) provided to the UE 101 by system information or dedicated signalling are not used in the cell selection process.

Cell Selection Criterion

The cell selection criterion S is fulfilled when:
Srxlev>0 AND Squal>0
   where:

Srxlev=Qᵣₓₗₑᵥₘₑₐₛ−(Qᵣₓₗₑᵥₘᵢₙ+Q_{rxlevminoffset})−P_{compensation}−Qoffsetₜₑₘₚ

Squal=Q_{qualmeas}−(Q_{qualmin}+Q_{qualminoffset})−Qoffsetₜₑₘₚ

where

| | |
|---|---|
| Srxlev | Cell selection receiving (RX) level value (decibel (dB)) |
| Squal | Cell selection quality value (dB) |
| Qoffsetₜₑₘₚ | Offset temporarily applied to a cell as specified in 3GPP |
| | TS 38.331 (dB) |
| Qᵣₓₗₑᵥₘₑₐₛ | Measured cell RX level value (RSRP) |
| Q_{qualmeas} | Measured cell quality value (RSRQ) |
| Qᵣₓₗₑᵥₘᵢₙ | Minimum required RX level in the cell (dBm). If the UE |
| | supports Supplementary Uplink Bands (SUL) frequency |
| | for this cell, Qrxlevmin is obtained from RxLevMinSUL, if |
| | present, in System Information Block 1 (SIB1), SIB2 and |
| | SIB4, additionally, if Q_{rxlevminoffsetcellSUL} is present in SIB3 |
| | and SIB4 for the concerned cell, this cell specific offset is |
| | added to the corresponding Qrxlevmin to achieve the |
| | required minimum RX level in the concerned cell; |
| | else Qrxlevmin is obtained from q-RxLevMin in SIB1 |
| | SIB1, SIB2 and SIB4, additionally, if Q_{rxlevminoffsetcell} is |
| | present in SIB3 and SIB4 for the concerned cell, this cell |
| | specific offset is added to the corresponding Qrxlevmin to |
| | achieve the required minimum RX level in the concerned |
| | cell. |
| Q_{qualmin} | Minimum required quality level in the cell (dB). |
| | Additionally, if Q_{qualminoffsetcell} is signalled for the concerned |
| | cell, this cell specific offset is added to achieve the |
| | required minimum quality level in the concerned cell. |
| Q_{rxlevminoffset} | Offset to the signalled Qᵣₓₗₑᵥₘᵢₙ taken into account in the |
| | Srxlev evaluation as a result of a periodic search for a |
| | higher priority Public Land Mobile Network (PLMN) while |
| | camped normally in a Visited Public Land Mobile |
| | Network (VPLMN) |
| Q_{qualminoffset} | Offset to the signalled Q_{qualmin} taken into account in the |
| | Squal evaluation as a result of a periodic search for a |
| | higher priority PLMN while camped normally in a VPLMN |
| P_{compensation} | If the UE supports the additionalPmax in the NS- |
| | PmaxList, if present, in SIB1, SIB2 and SIB4: |
| | max(P_{EMAX1} − P_{PowerClass}, 0) − (min(P_{EMAX2}, P_{PowerClass}) − |
| | min(P_{EMAX1}, P_{PowerClass})) (dB); |
| | else: |
| | max(P_{EMAX1} − P_{PowerClass}, 0) (dB) |
| P_{EMAX1}, | Maximum transmitting (TX) power level of a UE may use |
| P_{EMAX2} | when transmitting on the uplink in the cell (dBm) defined |
| | as P_{EMAX} in 3GPP TS 38.101. P_{EMAX1} and P_{EMAX2} are |
| | obtained from the p-Max and NS-PmaxList respectively |
| | in SIB1, SIB2 and SIB4 as specified in 3GPP TS 38.331. |
| P_{PowerClass} | Maximum RF output power of the UE (dBm) according to |
| | the UE power class as defined in 3GPP TS 38.101 |

RSRP used in the table above is short for Reference Signal Received Power. RSRQ is short for Reference Signal Received Quality.

The signalled values Q_{rxlevminoffset} and Q_{qualminoffset} are only applied when a cell is evaluated for cell selection as a result of a periodic search for a higher priority PLMN while camped normally in a VPLMN. During this periodic search for higher priority PLMN, the UE 101 may check the S criterion of a cell using parameter values stored from a different cell of this higher priority PLMN.

E-UTRAN Case in Cell Selection

The cell selection criterion and procedures in E-UTRAN are specified in TS 36.304. E-UTRAN is short for Evolved UTRAN, UTRAN is short for UMTS Terrestrial Radio Access Network and UMTS is short for Universal Mobile Telecommunications System.

Intra-Frequency and Equal Priority Inter-Frequency Cell Reselection Criterion

The cell-ranking criterion Rₛ for serving cell and Rₙ for neighbouring cells is defined by:

Rₛ=Q_{meas,s}+Q_{hyst}−Qoffsetₜₑₘₚ

Rₙ=Q_{meas,n}−Qoffset−Qoffsetₜₑₘₚ

where:

| | |
|---|---|
| Qₘₑₐₛ | Reference Signal Received Power (RSRP) |
| | measurement quantity used in cell reselections. |
| Qoffset | For intra-frequency: Equals to Qoffset_{s, n}, if Qoffset_{s, n} |
| | is valid, otherwise this equals to zero. |
| | For inter-frequency: Equals to Qoffset_{s, n} plus |
| | Qoffset_{frequency}, if Qoffset_{s, n} is valid, otherwise this |
| | equals to Qoffset_{frequency}. |
| Qoffsetₜₑₘₚ | Offset temporarily applied to a cell |

The UE 101 shall perform ranking of all cells that fulfil the cell selection criterion S, which is defined above.

The cells shall be ranked according to the R criterion specified above by deriving Q_{meas,n} and Q_{meas,s} and calculating the R values using averaged RSRP results.

If rangeToBestCell is not configured, the UE 101 shall perform cell reselection to the highest ranked cell. If this cell is found to be not-suitable, the UE 101 shall behave in another way.

If rangeToBestCell is configured, then the UE 101 shall perform cell reselection to the cell with the highest number of beams above the threshold (i.e. absThreshSS-BlocksConsolidation) among the cells whose R value is within rangeToBestCell of the R value of the highest ranked cell. If there are multiple such cells, the UE 101 shall perform cell reselection to the highest ranked cell among them. If this cell is found to be not-suitable, the UE 101 shall behave in another way.

In all cases, the UE 101 shall reselect the new cell, only if the following conditions are met:
1) The new cell is better ranked than the serving cell during a time interval Treselection_{RAT};
2) More than 1 second has elapsed since the UE 101 camped on the current serving cell.

In scenarios when more than one cell is configured as part of the handover command, e.g. the RRCConnectionReconfiguration message sent from the serving cell, there can be scenarios when more than one target cell fulfils the conditions that are configured in the conditional handover command. In such a scenario, it is not clear as which cell the UE 101 shall choose for handover execution.

Therefore, there is a need to at least mitigate or solve this issue.

### SUMMARY

An objective is therefore to obviate at least one of the above disadvantages and to provide improved handover of a UE from a source cell to a target cell.

According to a first aspect, the object is achieved by a method performed by a UE for initiating handover of the UE from a source cell to a target cell. The UE selects, based on at least one parameter, a target cell from multiple candidate target cells. The each candidate target cell of the multiple candidate target cells fulfills a criterion. The criterion may be a handover criterion or a conditional handover criterion. The criterion may be initiation of handover of the UE 101 to a candidate target cell. The UE initiates handover of the UE from the source cell to the selected target cell.

According to a second aspect, the object is achieved by a method performed by a first network node for initiating handover of the UE from a source cell to a target cell. The first network node provides, to the UE, information indicating the at least one parameter on which the UE should base its selection of target cell from multiple candidate target cells. The each candidate target cell of the multiple candidate target cells fulfils a criterion. The criterion may be a handover criterion or a conditional handover criterion. The criterion may be initiation of handover of the UE 101 to a candidate target cell.

Thanks to the at least one parameter, it is possible for the UE tot select a target cell can when there are multiple candidate target cell that fulfils a criterion. The criterion may be referred to as a conditional handover criterion. The criterion may be a handover criterion or a conditional handover criterion. The criterion may be initiation of handover of the UE 101 to a candidate target cell.

The presents disclosure herein afford many advantages, of which a non-exhaustive list of examples follows:

An advantage is that they ensure that measurements for the selection quantity are available.

Another advantage is that they provide an improved selection of target cell.

The present disclosure is not limited to the features and advantages mentioned above. A person skilled in the art will recognize additional features and advantages upon reading the following detailed description.

### BRIEF DESCRIPTION OF THE DRAWINGS

The present disclosure will now be further described in more detail by way of example only in the following detailed description by reference to the appended drawings and in which:

FIG. 1a is a flow chart illustrating a handover procedure.

FIG. 1b is a flow chart illustrating a handover procedure.

FIG. 2 is a flow chart illustrating a conditional handover execution.

FIG. 3 is a schematic diagram illustrating a communications system.

FIG. 4 is a signaling diagram illustrating a method.

FIG. 100a is a schematic drawing illustrating a UE.

FIG. 100b is a schematic drawing illustrating a UE.

FIG. 200a is a schematic drawing illustrating a network node.

FIG. 200b is a schematic drawing illustrating a network node.

FIG. 320 is a schematic block diagram illustrating a telecommunication network connected via an intermediate network to a host computer.

FIG. 330 is a schematic block diagram of a host computer communicating via a network node with a UE over a partially wireless connection.

FIG. 340 is a flowchart depicting a method in a communications system including a host computer, a base station and a UE.

FIG. 350 is a flowchart depicting a method in a communications system including a host computer, a base station and a UE.

FIG. 360 is a flowchart depicting a method in a communications system including a host computer, a base station and a UE.

FIG. 370 is a flowchart depicting a method in a communications system including a host computer, a base station and a UE.

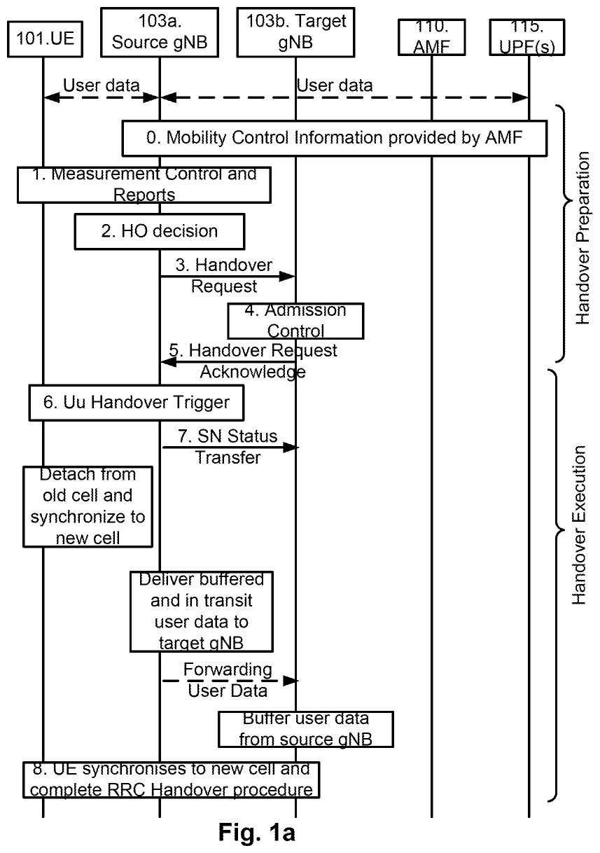

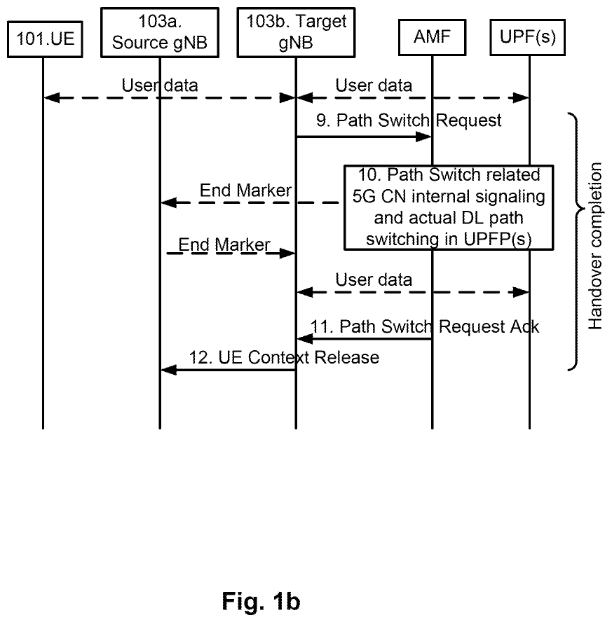

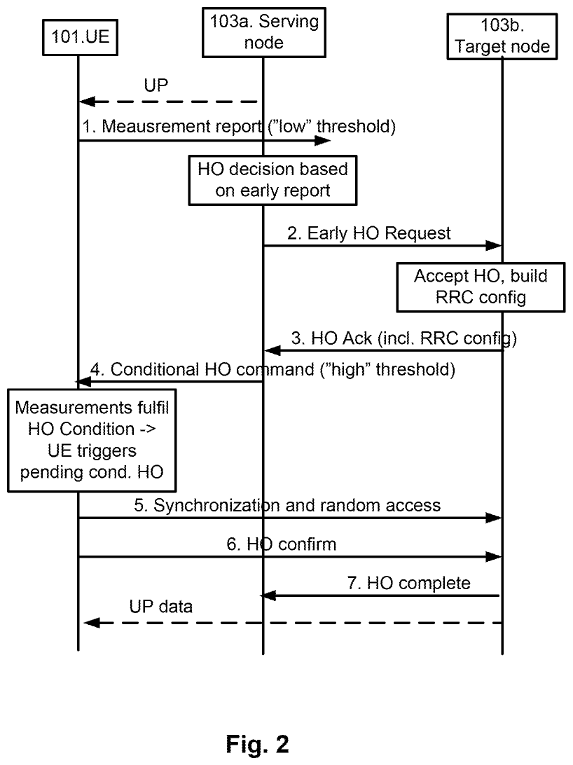

The drawings are not necessarily to scale and the dimensions of certain features may have been exaggerated for the sake of clarity. Emphasis is instead placed upon illustrating the principle.

### DETAILED DESCRIPTION

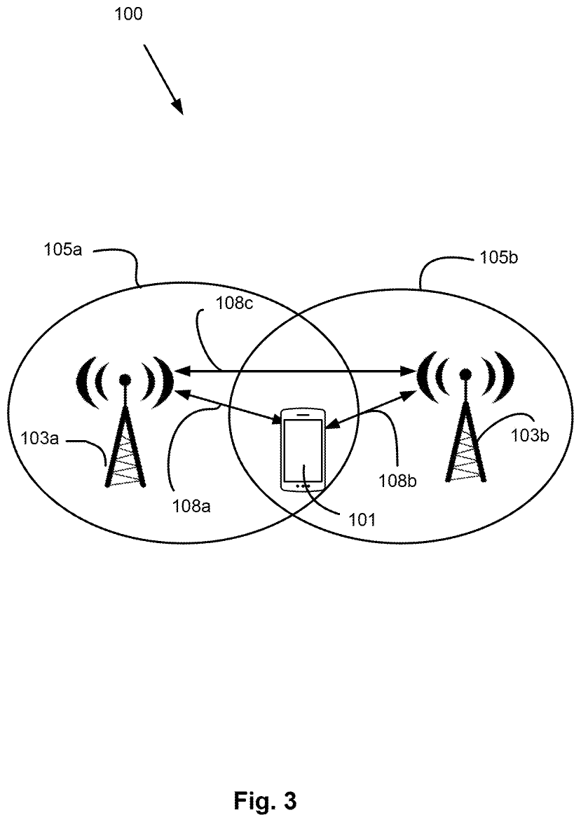

FIG. 3 depicts a communications system 100, which may be a wireless communications system, sometimes also referred to as a wireless communications network, cellular radio system, or cellular network. The communications system 100 may be a Second Generation (2G) system, a Third Generation (3G) system, a Fourth Generation (4G) system a Fifth Generation (5G) system, 5G network, NR-U or Next Gen system or network. The communications system 100 may alternatively be a younger or older system than a 5G system, it may be a legacy system or a further system. The communications system 100 may support other technologies such as, for example, LTE, LTE-Advanced/LTE-Advanced Pro, e.g. LTE Frequency Division Duplex (FDD), LTE Time Division Duplex (TDD), LTE Half-Duplex Frequency Division Duplex (HD-FDD), LTE operating in an unlicensed band, Node B— Internet of Things (NB-IoT). Thus, although terminology from 5G, NR and LTE may be used in this disclosure, this should not be seen as limiting the scope to only the aforementioned systems.

The communications system 100 comprises one or a plurality of network nodes, whereof a first network node 103a and a second network node 103b are depicted in FIG. 3. Any of the first network node 103a and the second network node 103a may be a radio network node, such as a radio base station, or any other network node with similar features capable of serving a UE 101, such as a wireless device or a machine type communication device, in the communications system 100. The first network node 103a may be an eNB and the second network node 103b may be a gNB. The first network node 103a may be a first eNB, and the second network node 103b may be a second eNB. The first network node 103a may be a first gNB, and the second network node 103b may be a second gNB. The first network node 103a may be a MeNB and the second network node 103b may be a gNB. Any of the first network node 103a and the second network node 103b may be co-localized, or be part of the same network node. The first network node 103a may be referred to as a source node or source network node, whereas the second network node 103b may be referred to as a target node or target network node. The first network node 103a may be referred to as a serving node or serving and the second network node 103b may be referred to as a target node or target. The first network node 103a may be the network node which currently serves the UE 101, and the second network node 103b may be the network node to which the UE 101 may be handed over, i.e. the second network node 103b is a candidate target node. When the reference number 103 is used herein without the letters a or b, it refers to a network node in general, i.e. it refers to any of the first network node 103a or second network node 103b.

The communications system 100 covers a geographical area which may be divided into cell areas, wherein each cell area may be served by a network node, although, one network node may serve one or several cells. In FIG. 3, the communications system 100 comprises a first cell 105a and a second cell 105b. Note that two cells are exemplified in FIG. 3 only as an example, and that any n number of cells may be comprised in the communication system, where n is any positive integer. A cell is a geographical area where radio coverage is provided by the network node at a network node site. Each cell is identified by an identity within the local network node area, which is broadcast in the cell. In FIG. 3, first network node 103a serves the first cell 105a, and the second network node 103b serves the second cell 105b. Any of the first network node 103a and the second network node 103b may be of different classes, such as, e.g., macro base station (BS), home BS or pico BS, based on transmission power and thereby also cell size. Any of the first network node 103a and the second network node 103b may be directly connected to one or more core networks, which are not depicted in FIG. 3 for the sake of simplicity. Any of the first network node 103a and the second network node 103b may be a distributed node, such as a virtual node in the cloud, and it may perform its functions entirely on the cloud, or partially, in collaboration with another network node. The first cell 105a may be referred to as a source cell, whereas the second cell 105b may be referred to as a target cell. When the reference number 105 is used herein without the letters a or b, it refers to a cell in general, i.e. it refers to any of the first cell 105a or second cell 105b.

One or a plurality of UEs 101 is located in the communication system 100. Only one UE 101 is exemplified in FIG. 3 for the sake of simplicity. A UE 101 may also be referred to simply as a device. The UE 101, e.g. a LTE UE or a 5G/NR UE, may be a wireless communication device which may also be known as e.g., a wireless device, a mobile terminal, wireless terminal and/or mobile station, a mobile telephone, cellular telephone, or laptop with wireless capability. The UE 101 may be a device by which a subscriber may access services offered by an operator's network and services outside operator's network to which the operator's radio access network and core network provide access, e.g. access to the Internet. The UE 101 may be any device, mobile or stationary, enabled to communicate over a radio channel in the communications network, for instance but not limited to e.g. user equipment, mobile phone, smart phone, sensors, meters, vehicles, household appliances, medical appliances, media players, cameras, Machine to Machine (M2M) device, IoT device, terminal device, communication device or any type of consumer electronic, for instance but not limited to television, radio, lighting arrangements, tablet computer, laptop or Personal Computer (PC). The UE 101 may be portable, pocket storable, hand held, computer comprised, or vehicle mounted devices, enabled to communicate voice and/or data, via the radio access network, with another entity, such as another UE, a server, a laptop, a Personal Digital Assistant (PDA), or a tablet, M2M device, device equipped with a wireless interface, such as a printer or a file storage device, modem, or any other radio network unit capable of communicating over a radio link in a communications system.

The UE 101 is enabled to communicate wirelessly within the communications system 100. The communication may be performed e.g. between two devices, between a devices and a regular telephone, between the UE 101 and a network node, between network nodes, and/or between the devices and a server via the radio access network and possibly one or more core networks and possibly the internet.

The first network node 103a may be configured to communicate in the communications system 100 with the UE 101 over a first communication link 108a, e.g., a radio link. The second network node 103b may be configured to communicate in the communications system 100 with the UE 101 over a second communication link 108b, e.g., a radio link. The first network node 103a may be configured to communicate in the communications system 100 with the second network node 103b over a third communication link 108c, e.g. a radio link or a wired link, although communication over more links may be possible.

It should be noted that the communication links in the communications network may be of any suitable kind including either a wired or wireless link. The link may use any suitable protocol depending on type and level of layer, e.g. as indicated by the Open Systems Interconnection (OSI) model, as understood by the person skilled in the art.

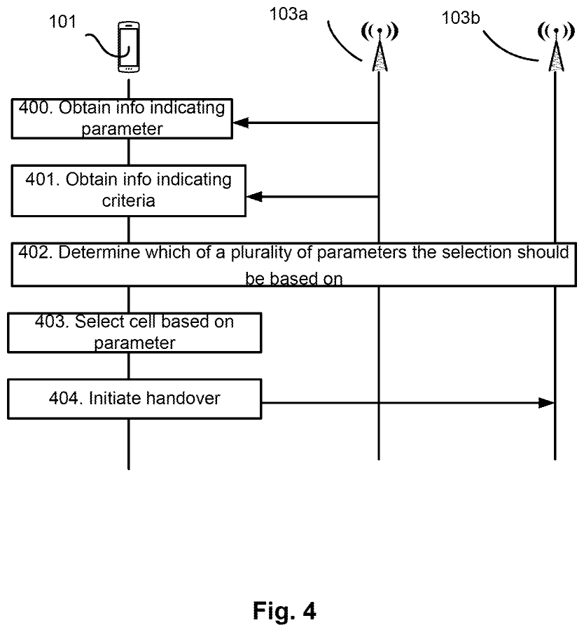

FIG. 4 is a signalling diagram illustrating an example of a method. The method may be for for initiating handover of the UE 101 from a source cell 105a to a target cell 105b. This may also be described as for handover of the UE 101 from a first network node 103a to a second network node 103b. At least one of the UE 101 and the first network node 103a may be comprised in a 2G system, a 3G system, a 4G system, a 5G system or any higher number system. The method may be performed in association with conditional handover. The method comprises at least one of the following steps, which step may be performed in any suitable order than described below:

Step 400

The UE 101 may obtain information indicating the at least one parameter, e.g. from the first network node 103a. The first network node 103a may provide information indicating the at least one parameter to the UE 101. The at least one parameter may be referred to as a quantity or a parameter type, and the at least one parameter may be for example RSRP, RSRQ, SINR etc.

The information indicating the parameter may be comprised in an RRCConnectionReconfiguration message or an RRCReconfiguration message.

The information indicating the parameter may be comprised in an information element (IE).

The information element may be a mobilityControlInfo information element or a ReconfigurationWithSync information element.

The parameter may be referred to as a selection parameter or a selection quantity or a rule or a measurement quantity.

Step 401

The UE 101 may obtain information indicating the criterion, e.g. from the first network node 103a. The criterion is the criterion which each of candidate target cells in the multiple candidate target cells fulfills. The first network node 103a may provide information indicating the criterion to the UE 101.

The criterion may be referred to as a triggering condition for conditional handover or a trigger quantity. In other words, some or all candidate target cells of the multiple candidate target cells fulfil the triggering condition for conditional handover. For example, two or more candidate target cells may fulfil the triggering condition. The criterion may be a handover criterion or a conditional handover criterion. The criterion may be initiation of handover of the UE 101 to a candidate target cell.

Step 402

The at least one parameter to be used in the selection in step 403 may be selected from a plurality of candidate parameters. The UE 101 or the first network node 103a or both the UE 101 and the first network node 103 may determine the at least one parameter from the plurality of parameters, i.e. they determine which of the plurality of parameters the selection in step 403 should be based on. The UE 101 or the first network node 103a or both the UE 101 and the first network node 103a may determine one or multiple parameters from the plurality of parameters.

This step may be referred to as at least one parameter type may be selected from a plurality of candidate parameter types.

Each candidate target cell of the multiple candidate target cells may have one or more associated parameter instance(s) of each of the at least one parameter or parameter type, and the UE 101 may select the target cell 105b based on comparing values of the respective parameter(s) instances associated with the respective candidate target cell. The value may be referred to as a measurement value of a parameter instance.

If the first network node 103a takes the decision or performs the selection, then it may provide the result of the decision to the UE 101, i.e. the result is the determined or selected at least one parameter. If the UE 101 takes the decision or performs the selection, then it may provide the result of the decision or selection to the first network node 103a, i.e. the resulting being the determined or selected at least one parameter.

Step 403

The UE 101 selects, based on at least one parameter, a target cell 105b from multiple candidate target cells. The each candidate target cell in the multiple candidate target cells fulfills a criterion. The term multiple refers to two or more. The criterion may be a handover criterion or a conditional handover criterion. The criterion may be initiation of handover of the UE 101 to a candidate target cell.

This step may also be described as the UE 101 selects, based on at least one parameter, a second network node 103b from multiple candidate second network nodes 103b.

Since each candidate target cell in the multiple candidate target cells fulfills the criterion, step 403 may be described as comprising the step of determining that the multiple candidate target cells fulfills the criterion.

The at least one parameter may be preconfigured in the UE 101, or it may be hardcoded in the UE 101 based on a standard specification or it may be obtained from the first network node 103a in step 400.

The at least one parameter may indicate that the target cell 105b is to be selected based on at least one of:
a) One or multiple triggering quantities; and/or
b) Cell selection/cell reselection criterion; and/or
c) UE implementation; and/or
d) Highest delta of at least one of:
   i. a strongest RSRP value; and/or
   ii. a strongest RSRQ value; and/or
   iii. a strongest Signal to Interference & Noise Ratio (SINR) value; and/or
   iv. a highest priority; and/or
   v. allocated RACH resources which are first occurring in time; and/or
   vi. a cell in which the UE 101 performed latest measurement; and/or
   vii. an intra-frequency; and/or
   viii. an inter-frequency; and/or
   ix. fulfilled a condition based on a combination of any of i-viii
e) Timing, e.g. the cell that first fulfilled the conditions is chosen; and/or
f) The cell with highest trigger quantity; and/or
g) The cell with highest “selection quantity”, where that is configurable; and/or
h) The cell with highest number of good #beams”; and/or
i) The cell with highest “selection quantity”, where that is based on a pre-defined rule; and/or
j) The greatest margin to the CHO execution trigger condition; and/or
k) A combination of the improvement speed and the margin to the CHO execution trigger condition; and/or
l) A combination of the improvement speed and the value of the trigger quantity; and/or
m) A combination of priority and cell selection/cell reselection criterion; and/or
n) A strongest RSRP value; and/or
o) A strongest RSRQ value; and/or
p) A strongest SINR value; and/or
q) A highest priority; and/or
r) Allocated RACH resources which are first occurring in time; and/or
s) A cell in which the UE performed latest measurement; and/or
t) An intra-frequency; and/or
u) An inter-frequency; and/or
v) A combination of frequency priorities and margin to the CHO trigger condition; and/or
w) A combination of frequency priorities and the value of the trigger quantity; and/or
x) A combination of any of a)-w

The at least one parameter may be at least one of a)-x) above.

Below are some possible options to select the target cell 105b:
1) When more than one condition as configured in the RRCConnectionReconfiguration message are fulfilled, the UE 101 may select the target cell based on one or more of the following. The parameter to be used (RSRP/SINR/RSRQ/highest prio/RACH resource availability etc.) for the selection could either be configured in the RRCConnectionReconfiguration message sent by the serving cell or this could be the mandated behavior in the specification or could be up to UE implementation. Amongst the cells that fulfil the condition;
   a. Select the cell which has the strongest RSRP value; or
   b. Select the cell which has the strongest RSRQ value; or
   c. Select the cell which has the strongest SINR value; or
   d. Select the cell which has the highest priority; or
   e. Select the cell whose allocated RACH resources are first occurring;
   f. (For measurements involving inter-frequency case, i.e., when the UE 101 needs measurement gap(s) to perform measurements, the UE 101 might not perform measurements every measurement interval but more seldom and interpolate the measurements in between those measurements and if the such interpolated measurements'-based decision satisfies the conditional handover related trigger) Select the cell in which the UE 101 has actually performed the measurement instead of using the interpolated measurement.
   g. (if the RRCConnectionReconfiguration message includes both intra-frequency and inter-frequency related handover messages) select the cell based on the following;
      i. The UE 101 may always prioritize the intra-frequency related handover execution. This is the solution that is more important for latency critical applications wherein performing an inter-frequency related handover might involve larger delay due to re-synchronization requirements in the new carrier. However, this solution reduces the possibility to have inter-frequency load sharing/balancing feature to use the conditional handover effectively.
      ii. The UE 101 may always prioritize the inter-frequency related handover execution. This is the solution that is more important for load sharing/balancing applications wherein the serving cell/frequency might be overloaded compared to the neighboring frequencies. However, this solution potentially increases the latency as the UE needs to resynchronize to the new frequency before performing handover execution.
      iii. The network may be able to provide priorities per target cell included in the conditional handover command independent of the frequencies to which these target cells belong to.
      iv. The network may provide two sets of priorities; one related to frequency specific priority and the other related to cell specific priority within a frequency carrier.

The at least one parameter may be referred to as a selection parameter, and the UE 101 may select the target cell 105b having the highest or lowest selection parameter, i.e. a selection parameter with a predetermined value, as compared to values of the other candidate parameters in the plurality of candidate parameters. The UE 101 may select as the target cell 105b the candidate target cell out of the multiple candidate target cells that has a predetermined value of the associated parameter instance of the at least one parameter. In other words, the UE 101 may select the target cell 105b having a predetermined value of the at least one parameter instance of the at least one parameter, where the predetermined value may be a highest or lowest value compared to values of the other (not selected) candidate parameters.

Step 404

The UE 101 initiates handover of the UE 101 from the source cell 105a to the selected target cell 105b, e.g. handover of the UE 101 to go from being served by the first network node 103a to being served by the second network node 103b.

Herein, the term “selection quantity” defines a measurement quantity to be used in case multiple cells 105 fulfill a triggering condition for conditional handover e.g. cell-A and cell-B. In that case, in general terms, the UE 101 selects the cell 105 with the highest “selection quantity” among cell-A and cell-B, or any other cell fulfilling the triggering condition.

The UE 101 may use the configured trigger quantity in the conditional handover/mobility configuration as the selection quantity. Hence, if RSRP is used as trigger quantity and both cells cell-A and cell-B, or any other cell, fulfills the condition, the UE 101 may also use RSRP as selection quantity. Else, if RSRQ is used as trigger quantity and both cells cell-A and cell-B, or any other cell, fulfills the condition, the UE 101 may also use RSRQ as selection quantity. Else, if SINR is used as trigger quantity and both cells cell-A and cell-B, or any other cell, fulfills the condition, the UE 101 may also use SINR as selection quantity.

The target cell 105b may be chosen based on multiple measurement quantities. The quantities to select from may be hard coded or configured by the first network node 103a. The trigger quantities may be at least one of: RSRP and/or RSRQ and/or SINR. They may be based on cell measurements i.e. cell level RSRP, cell level RSRQ, cell level SINR. When the method describes the triggering of a condition based on multiple trigger quantities, the method may comprise at least the one of following configurations:
RSRP and RSRQ;
RSRP and SINR;
RSRQ and SINR;
RSRP, RSRQ and SINR;

When the method describes the fulfillment of conditions associated to multiple quantities, the method may comprise the monitoring of multiple conditions in parallel and, selecting the target cell for CHO based on the cell with the best combination of the triggering quantities. The selection in such case may be based on a pre-defined arbitrary quantity depending which quantities are configured as trigger quantities, for example, as follows:
RSRP and RSRQ→selection quantity is RSRP;
RSRP and SINR→selection quantity is RSRP;
RSRQ and SINR→selection quantity is RSRQ;
RSRP, RSRQ and SINR→selection quantity is RSRP.

In more general terms, the UE selection quantity may determine how the UE 101 shall select a cell in case multiple cells fulfill the triggering condition so that the UE determines which cell the UE shall select to execute conditional handover/mobility.

The UE 101 may be configured with a separated parameter for the “selection quantity”. That works for both single trigger quantity and multiple trigger quantities, and does not have to be associated with them. When configured, the UE 101 may perform measurements based on that configured selection quantity. Hence, if RSRP is used as trigger quantity and both cells cell-A and cell-B, or any other cell. fulfills the condition, the UE 101 may also use the configured parameter selection quantity which may be e.g. same as trigger, RSRP, RSRQ, SINR, etc.

The UE 101 may perform the selection of cell, in case of multiple trigger cells, based on a selection quantity defined based on a pre-defined rule such as:
Use RSRP as selection quantity if available i.e. if UE has RSRP measurements for the triggered cells so it can choose the one with highest RSRP; or
Else, use RSRQ as selection quantity if available, and if RSRP is not available. That may occur if for the monitored cells, the UE 101 is not configured to perform RSRP measurements.
Else, use SINR;

The UE 101 may perform the selection of cell (in case of multiple trigger cells) based on a selection quantity defined based on the configured quantity, if configured, or pre-defined rule if the quantity is not configured, where the rule is for example as follows:
If selection quantity is configured, use it in case multiple cells are triggered e.g. if RSRP is configured, select the cell with highest RSRP.
Else, use RSRP as selection quantity if available i.e. if the UE 101 has RSRP measurements for the triggered cells so it can choose the one with highest RSRP; or
Else, use RSRQ as selection quantity if available, and if RSRP is not available. That may occur if for the monitored cells, the UE 101 may not be configured to perform RSRP measurements.
Else, use SINR.

The UE 101 may perform the selection based on beam measurement information for the triggered cells. Beam measurement information may be beam measurements, e.g. beam-based RSRP, RSRQ or SINR, based on a reference signal like Synchronization Signal (SS) Block, Channel State Information-Reference Signal (CSI-RS), TSS, Cell Specific Reference Signal (CRS), etc., or other information derived from measurement such as per beam index.

The UE 101 may select the cell with highest number of detected beams among the cells fulfilling the triggering condition.

The UE 101 may select the cell with highest number of good beams (among the cells fulfilling the triggering condition). The good beams may be defined as the ones whose measurement quantity is above a pre-determined or configurable threshold.

The UE 101 may select the cell with the strongest best beam (among the cells fulfilling the triggering condition). Each cell may have their best beam based on a quantity, e.g. RSRP, RSRQ, SINR, which may either be configurable or pre-defined.

It may be assumed that there are multiple cells triggering the condition e.g. based on a single cell based quantity, like RSRP e.g. cell-A and cell-B have an RSRP difference with Primary Cell (PCell) higher than a threshold, with cell-A having slightly higher RSRP difference than cell-B. According to the prior art, the UE 101 may select cell-A.

However, especially in NR where a cell 105 may be comprised of multiple beams, cell-A may have a higher number of good beams than cell-B e.g. cell-A has 4 good beams while cell-B has a single good beam. Hence, the selection only based on RSRP may not be the best alternative, as cell-B could be a much more reliable and robust target candidate. Hence, base the selection on the cell having the highest number of good beams is a better strategy.

The target cell 105b may be chosen based on the cell selection/cell reselection rules that exist in 3GPP TS 38.304/36.304. The UE 101 may choose the strongest cell 105 according to the cell selection criterion, among the cells configured for conditional handover which all fulfil the condition. The selection of the cell 105b may be based on stored information from previously detected cells.

Alternatively, the UE 101 may use parts of the cell reselection criterion to rank the cells which all fulfil the criterion for conditional handover and choose the cell which the best ranking.

The target cell 105b is chosen purely based on UE implementation when multiple cells fulfil the conditions configured by the first network node 103a.

The target cell 105b may be based on the highest change in any/multiple of the triggering quantities. The UE 101 may select the cell 105 where any triggering quantity/quantities e.g. the RSRP is increasing the most.

The target cell 105b may be chosen based on timing. The cell 105 that first fulfilled the conditions may be chosen. The present disclosure relate to the case when multiple cells fulfil the conditions, but the conditions are unlikely fulfilled at exactly the same time in multiple cells, but multiple cells may fulfil the condition before the handover is actually executed.

Any of the following selection criterions may be used:
Selecting the target cell 105b based on the greatest margin to the CHO execution trigger condition. Note that different potential target cells 105 may have different execution trigger conditions.
Selecting the target cell 105b based on a combination of the improvement speed, i.e. the trigger quantity derivative, and the margin to the CHO execution trigger condition. The rationale is that a cell 105 with a high derivative may be expected to “overtake” and soon become better than another cell 105 with a lower derivative, even if the other cell currently has slightly better/higher absolute trigger quantity, e.g. RSRP, value. If the measurement interval is the same for all potential target cells, which can be expected at least for potential target cells on the same carrier frequency, the “delta” of a trigger quantity, e.g. RSRP or RSRQ, can be a measure of the trigger quantity derivative. If the measurement interval differs, then the trigger quantity can be calculated as the delta divided by the measurement interval, possibly averaged, using linear or exponential averaging, over multiple measurement intervals.
Selecting the target cell 105b based on a combination of the improvement speed, i.e. the trigger quantity derivative, and the value of the trigger quantity. I.e. this is similar to the preceding criterion, but without comparing the trigger quantity value with the CHO execution trigger condition.

The target cell 105b may be selected based on a combination of any of the methods listed herein. One such combination could e.g. be a combination of priority and cell selection/cell reselection criterion. The target cell 105b may have to fulfil the cell selection criterion, but among those cells 105 that fulfil the criterion the cell 105 with the highest priority is chosen.

Another combination of methods may e.g. be combination of measuring quantities like RSRP and priorities, but any combination is possible.

Another combination of selection criterion may be a combination of frequency priorities and margin to the CHO trigger condition or a combination of frequency priorities and the value of the trigger quantity. For instance, a UE 101 may be configured to prioritize potential target cells on frequency F1 over potential target cells on frequency F2, unless the potential target cell on F2 has a margin to its CHO trigger condition that is an offset greater than the corresponding margin of the potential target cell on F1.

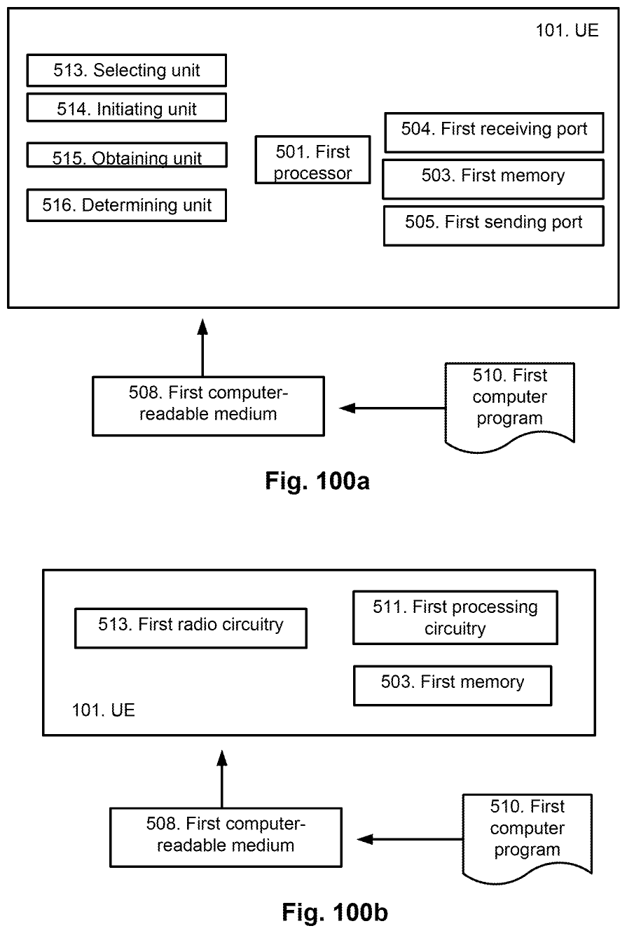

FIG. 100a and FIG. 100b depict two different examples in panels a) and b), respectively, of the arrangement that the UE 101 may comprise. The UE 101 may comprise the following arrangement depicted in FIG. 100a.

The UE 101 may be implemented through one or more processors, such as a first processor 501 in the UE 101 depicted in FIG. 100a, together with computer program code for performing the functions and actions herein. A processor, as used herein, may be understood to be a hardware component. The program code mentioned above may also be provided as a computer program product, for instance in the form of a data carrier carrying computer program code for performing the methods described herein when being loaded into the UE 101. One such carrier may be in the form of a CD ROM disc. It is however feasible with other data carriers such as a memory stick. The computer program code may furthermore be provided as pure program code on a server and downloaded to the UE 101.

The UE 101 may further comprise a first memory 503 comprising one or more memory units. The memory 503 is arranged to be used to store obtained information, store data, configurations, schedulings, and applications etc. to perform the methods herein when being executed in the UE 101.

The UE 101 may receive information from, e.g. the network node 103, through a first receiving port 504. The first receiving port 504 may be connected to one or more antennas in UE 101. The UE 101 may receive information from another structure in the communications system 100 through the first receiving port 504. Since the first receiving port 504 may be in communication with the first processor 501, the first receiving port 504 may then send the received information to the first processor 501. The first receiving port 504 may also be configured to receive other information.

The first processor 501 in the UE 101 may be configured to transmit or send information to e.g. the first network node 103a and/or the second network node 103b, or another structure in the communications system 100, through a first sending port 505, which may be in communication with the first processor 510, and the first memory 503.

The UE 101 may be adapted to, e.g. by means of a selecting unit 513, select, based on at least one parameter, a target cell 105b from multiple candidate target cells. Each candidate target cell in the multiple candidate target cells fulfills a criterion. The criterion may be a handover criterion or a conditional handover criterion. The criterion may be initiation of handover of the UE 101 to a candidate target cell. Since each candidate target cell in the multiple candidate target cells fulfills the criterion, the UE 101 may be adapted to determine that the multiple candidate target cells fulfill the criterion.

The UE 101 may be adapted to, e.g. by means of an initiating unit 514, initiate handover of the UE 101 from the source cell 105a to the selected target cell 105b.

The UE 101 may be adapted to, e.g. by means of an obtaining unit 515, obtain information indicating the at least one parameter, e.g. from the first network node 103a.

The at least one parameter may be preconfigured in the UE 101, or it may be hardcoded in the UE 101 based on a standard specification or it may be obtained from the first network node 103a in step 400.

The UE 101 may be adapted to, e.g. by means of a determining unit 516, determine which of a plurality of parameters the selection should be based on. This may be described as the UE 101 may be adapted to, e.g. by means of the determining unit 516, select the at least one parameter from a plurality of candidate parameters.

The UE 101 may be adapted to, e.g. by means of the obtaining unit 515, obtain information indicating the criterion, e.g. from the first network node 103a. The criterion may be a handover criterion or a conditional handover criterion. The criterion may be initiation of handover of the UE 101 to a candidate target cell.

The at least one parameter indicates that the target cell 105b to be selected may be based on at least one of:
a) One or multiple triggering quantities; and/or
b) Cell selection/cell reselection criterion; and/or
c) UE implementation; and/or
d) Highest delta of at least one of:
   i. a strongest RSRP value; and/or
   ii. a strongest RSRQ value; and/or
   iii. a strongest SINR value; and/or
   iv. a highest priority; and/or
   v. allocated RACH resources which are first occurring in time; and/or
   vi. a cell in which the UE performed latest measurement; and/or
   vii. an intra-frequency; and/or
   viii. an inter-frequency; and/or
   ix. fulfilled a condition based on a combination of any of i-viii
e) Timing, e.g. the cell that first fulfilled the conditions is chosen; and/or
f) The cell with highest trigger quantity; and/or
g) The cell with highest selection quantity, where that is configurable; and/or
h) The cell with highest number of good #beams”; and/or
i) The cell with highest selection quantity, where that is based on a pre-defined rule; and/or
j) The greatest margin to the CHO execution trigger condition; and/or
k) A combination of the improvement speed and the margin to the CHO execution trigger condition; and/or
l) A combination of the improvement speed and the value of the trigger quantity; and/or
m) A combination of priority and cell selection/cell reselection criterion; and/or
n) A strongest RSRP value; and/or
o) A strongest RSRQ value; and/or
p) A strongest SINR value; and/or
q) A highest priority; and/or
r) Allocated RACH resources which are first occurring in time; and/or
s) A cell in which the UE 101 performed latest measurement; and/or
t) An intra-frequency; and/or
u) An inter-frequency; and/or
v) A combination of frequency priorities and margin to the CHO trigger condition; and/or
w) A combination of frequency priorities and the value of the trigger quantity; and/or
x) A combination of any of a)-w

The at least one parameter may be referred to as a selection parameter, and the UE 101 may be adapted to, e.g. by means of the selecting unit 513, select the target cell 105b having the highest selection parameter. In other words, the UE 101 may select the target cell 105b having a highest value of the at least one parameter compared to values of the other candidate parameters in the plurality of candidate parameters.

The information indicating the parameter may be comprised in an RRCConnectionReconfiguration message or an RRCReconfiguration message.

The information indicating the parameter may be comprised in an information element.

The information element may be a mobilityControlInfo information element or an ReconfigurationWithSync information element.

The UE 101 may be comprised in a 2G system, a 3G system, a 4G system, a 5G system or any higher number system.

Those skilled in the art will also appreciate that the selecting unit 513, the initiating unit 514, the obtaining unit 515, the determining unit 516 etc., described above may refer to a combination of analog and digital circuits, and/or one or more processors configured with software and/or firmware, e.g., stored in memory, that, when executed by the one or more processors such as the first processor 501, perform as described above. One or more of these processors, as well as the other digital hardware, may be included in a single Application-Specific Integrated Circuit (ASIC), or several processors and various digital hardware may be distributed among several separate components, whether individually packaged or assembled into a System-on-a-Chip (SoC).

The different units 513-516 described above may be implemented as one or more applications running on one or more processors such as the first processor 501.

Thus, the methods described herein for the UE 101 may be respectively implemented by means of a first computer program 521 product, comprising instructions, i.e., software code portions, which, when executed on at least one first processor 501, cause the at least one first processor 501 to carry out the actions described herein, as performed by the UE 101. The first computer program 521 product may be stored on a first computer-readable storage medium 520. The first computer-readable storage medium 520, having stored thereon the first computer program 521, may comprise instructions which, when executed on at least one first processor 501, cause the at least one first processor 501 to carry out the actions described herein, as performed by the UE 101. The first computer-readable storage medium 520 may be a non-transitory computer-readable storage medium, such as a CD ROM disc, or a memory stick. The first computer program 521 product may be stored on a carrier containing the first computer program 521 just described. The carrier is one of an electronic signal, optical signal, radio signal, or the first computer-readable storage medium 508, as described above.

The UE 101 may comprise a communication interface configured to facilitate communications between the UE 101 and other nodes or devices, e.g., the first network node 103a and/or the second network node 103b, or another structure. The interface may comprise a transceiver configured to transmit and receive radio signals over an air interface in accordance with a suitable standard.

The UE 101 may comprise the following arrangement depicted in FIG. 100b. The UE 101 may comprise a first processing circuitry 515, e.g., one or more processors such as the first processor 510, in the UE 101 and the first memory 503. The UE 101 may also comprise a first radio circuitry 514, which may comprise e.g. the first receiving port 504 and the first sending port 505. The first processing circuitry 515 may be configured to, or operable to, perform the method actions according to FIG. 4, in a similar manner as that described in relation to FIG. 100a. The first radio circuitry 514 may be configured to set up and maintain at least a wireless connection with the UE 101. Circuitry may be understood herein as a hardware component.

The UE 101 is operative to operate in the communications system 100. The UE 101 may comprise the first processing circuitry 511 and the first memory 503. The first memory 503 comprises instructions executable by said first processing circuitry 511. The UE 101 is further operative to perform the actions described herein in relation to the UE 101, e.g. in FIG. 4.

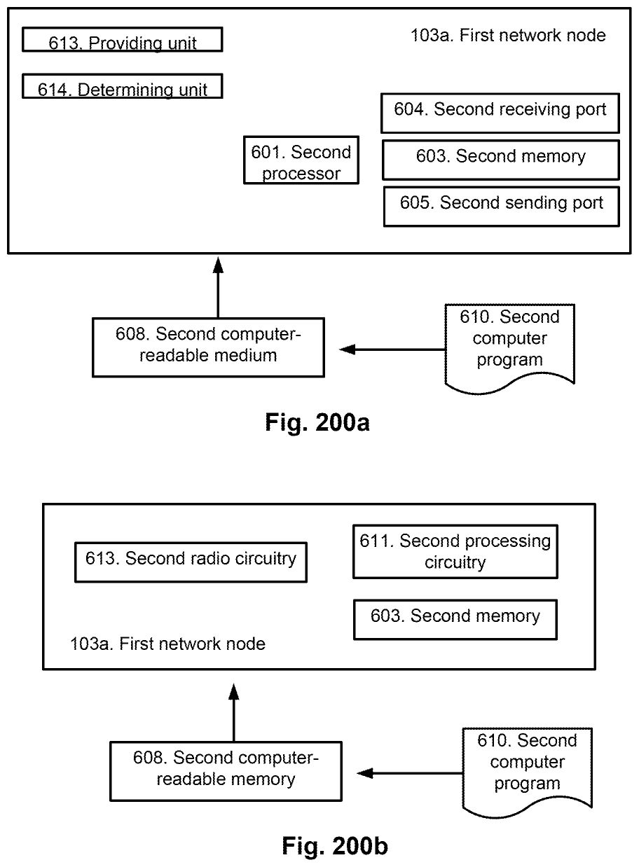

FIG. 200a and FIG. 200b depict two different examples in panels a) and b), respectively, of the arrangement that the first network node 103a may comprise. The network node 105 may comprise the following arrangement depicted in FIG. 100a.

The present disclosure in the first network node 103a may be implemented through one or more processors, such as a second processor 601 in the first network node 103a depicted in FIG. 200a, together with computer program code for performing the functions and actions described herein. A processor, as used herein, may be understood to be a hardware component. The program code mentioned above may also be provided as a computer program product, for instance in the form of a data carrier carrying computer program code for performing the methods described herein when being loaded into the network node 103. One such carrier may be in the form of a CD ROM disc. It is however feasible with other data carriers such as a memory stick. The computer program code may furthermore be provided as pure program code on a server and downloaded to first network node 103a and/or the second network node 103b.

The first network node 103a may further comprise a second memory 603 comprising one or more memory units. The second memory 603 is arranged to be used to store obtained information, store data, configurations, schedulings, and applications etc. to perform the methods herein when being executed in the first network node 103a.

The first network node 103a may receive information from, e.g., the UE 101 and/or the second network node 103b, through a second receiving port 604. The second receiving port 604 may be connected to one or more antennas in first network node 103a. The first network node 103a may receive information from another structure in the communications system 100 through the second receiving port 604. Since the second receiving port 604 may be in communication with the second processor 601, the second receiving port 604 may then send the received information to the second processor 601. The second receiving port 604 may also be configured to receive other information.

The second processor 601 in the first network node 103a may be configured to transmit or send information to e.g., the UE 101 or another structure in the communications system 100, through a second sending port 605, which may be in communication with the second processor 601, and the second memory 603.

The first network node 103a may be adapted to, e.g. by means of a providing unit 613, provide, to the UE 101, information indicating the at least one parameter on which the UE 101 should base its selection of target cell 105b from multiple candidate target cells. Each candidate target cell of the multiple candidate target cells fulfills a criterion. The criterion may be a handover criterion or a conditional handover criterion. The criterion may be initiation of handover of the UE 101 to a candidate target cell.

The first network node 103a may be adapted to, e.g. by means of a determining unit 614, determine which of a plurality of parameters the selection should be based on. In other words, the network node 103 may be adapted to determine or select the at least one parameter from a plurality of candidate parameters.

The first network node 103a may be adapted to, e.g. by means of the providing unit 613, provide information indicating the handover criterion to the UE 101.

The at least one parameter may indicate that the target cell is to be selected based on at least one of:
a) One or multiple triggering quantities; and/or
b) Cell selection/cell reselection criterion; and/or
c) UE implementation; and/or
d) Highest delta of at least one of:
   i. a strongest RSRP value; and/or
   ii. a strongest RSRQ value; and/or
   iii. a strongest SINR value; and/or
   iv. a highest priority; and/or
   v. allocated RACH resources which are first occurring in time; and/or
   vi. a cell in which the UE performed latest measurement; and/or
   vii. an intra-frequency; and/or
   viii. an inter-frequency; and/or
   ix. fulfilled a condition based on a combination of any of i-viii
e) Timing, e.g. the cell that first fulfilled the conditions is chosen; and/or
f) The cell with highest trigger quantity; and/or
g) The cell with highest “selection quantity”, where that is configurable; and/or
h) The cell with highest number of good #beams”; and/or
i) The cell with highest “selection quantity”, where that is based on a pre-defined rule; and/or
j) The greatest margin to the CHO execution trigger condition; and/or
k) A combination of the improvement speed and the margin to the CHO execution trigger condition; and/or
l) A combination of the improvement speed and the value of the trigger quantity; and/or
m) A combination of priority and cell selection/cell reselection criterion; and/or
n) A strongest RSRP value; and/or
o) A strongest RSRQ value; and/or
p) A strongest SINR value; and/or
q) A highest priority; and/or
r) Allocated RACH resources which are first occurring in time; and/or
s) A cell in which the UE performed latest measurement; and/or
t) An intra-frequency; and/or
u) An inter-frequency; and/or
v) A combination of frequency priorities and margin to the CHO trigger condition; and/or
w) A combination of frequency priorities and the value of the trigger quantity; and/or
x) A combination of any of y)-uu).

The at least one parameter may be referred to a selection parameter. In other words, the first network node 103a may determine or select the target cell 105b having a highest value of the at least one parameter compared to values of the other candidate parameters in the plurality of candidate parameters.

The information indicating the parameter may be comprised in an RRCConnectionReconfiguration message or an RRCReconfiguration message.

The information indicating the parameter may be comprised in an information element.

The information element may be a mobilityControlInfo information element or an ReconfigurationWithSync information element.

The first network node 103a may be comprised in a 2G system, a 3G system, a 4G system, a 5G system or any higher number system.

The providing unit 613, the determining unit 614 etc. described above may refer to a combination of analog and digital circuits, and/or one or more processors configured with software and/or firmware, e.g., stored in memory, that, when executed by the one or more processors such as the second processor 601, perform as described above. One or more of these processors, as well as the other digital hardware, may be included in a single ASIC, or several processors and various digital hardware may be distributed among several separate components, whether individually packaged or assembled into a SoC.

The different units 613-614 described above may be implemented as one or more applications running on one or more processors such as the second processor 601.

Thus, the methods described herein for the first network node 103a may be respectively implemented by means of a second computer program 610 product, comprising instructions, i.e., software code portions, which, when executed on at least one second processor 601, cause the at least one second processor 601 to carry out the actions described herein, as performed by the first network node 103a. The second computer program 610 product may be stored on a second computer-readable storage medium 608. The computer-readable storage medium 608, having stored thereon the second computer program 610, may comprise instructions which, when executed on at least one second processor 601, cause the at least one second processor 601 to carry out the actions described herein, as performed by the first network node 103a. The computer-readable storage medium 610 may be a non-transitory computer-readable storage medium, such as a CD ROM disc, or a memory stick. The second computer program 610 product may be stored on a carrier containing the second computer program 610 just described, wherein the carrier is one of an electronic signal, optical signal, radio signal, or the second computer-readable storage medium 608, as described above.

The first network node 103a may comprise a communication interface configured to facilitate communications between the first network node 103a and other nodes or devices, e.g., the UE 101 and/or the second network node 103b, or another structure. The interface may comprise a transceiver configured to transmit and receive radio signals over an air interface in accordance with a suitable standard.

The first network node 103a may comprise the following arrangement depicted in FIG. 200b. The first network node 103a may comprise a second processing circuitry 611, e.g., one or more processors such as the second processor 601, in the network node 103 and the second memory 603. The network node 103 may also comprise a second radio circuitry 613, which may comprise e.g., the second receiving port 604 and the second sending port 605. The second processing circuitry 611 may be configured to, or operable to, perform the method actions according to FIG. 4 in a similar manner as that described in relation to FIG. 200a. The second radio circuitry 613 may be configured to set up and maintain at least a wireless connection with the network node 103. Circuitry may be understood herein as a hardware component.

The first network node 103a is operative to operate in the communications system 100. The first network node 103a may comprise the second processing circuitry 613 and the second memory 603. The second memory 603 comprises instructions executable by said second processing circuitry 613. The first network node 103a is operative to perform the actions described herein in relation to the network node 105, e.g., in FIG. 4.

Further Extensions and Variations

A telecommunication network is connected via an intermediate network to a host computer.

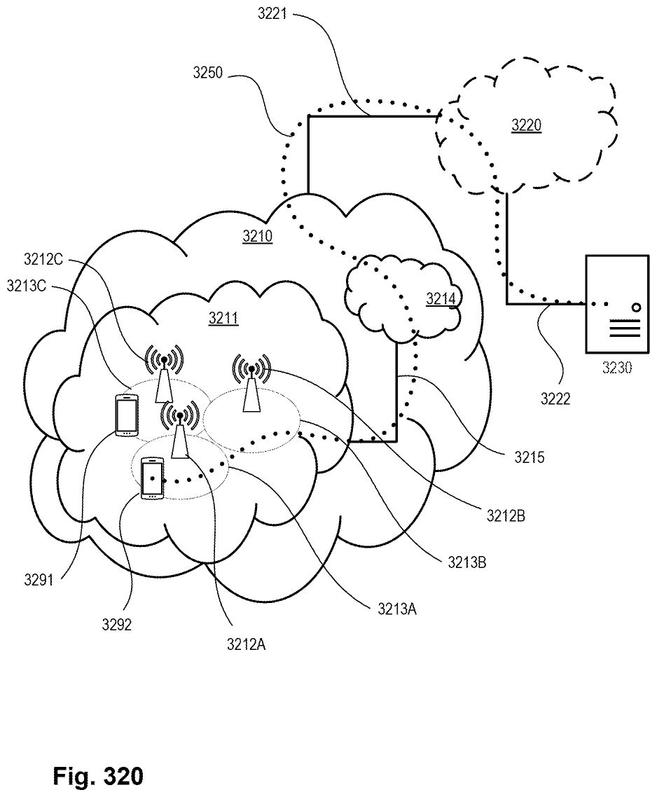

With reference to FIG. 320, a communication system includes telecommunication network 3210 such as the communications system 100, for example, a 3GPP-type cellular network, which comprises access network 3211, such as a radio access network, and core network 3214. Access network 3211 comprises a plurality of network nodes 105. For example, base stations 3212a, 3212b, 3212c, such as NBs, eNBs, gNBs or other types of wireless access points, each defining a corresponding coverage area 3213a, 3213b, 3213c. Each base station 3212a, 3212b, 3212c is connectable to core network 3214 over a wired or wireless connection 3215. A plurality of user equipments, such as the UE 101 may be comprised in the communications system 100. In FIG. 320, a first UE 3291 located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in FIG. 320, there may be a situation where a sole UE is in the coverage area or where a sole UE is connecting to the corresponding base station 3212. Any of the UEs 3291, 3292 may be considered examples of the UE 101.

Telecommunication network 3210 is itself connected to host computer 3230, which may be embodied in the hardware and/or software of a standalone server, a cloud-implemented server, a distributed server or as processing resources in a server farm. Host computer 3230 may be under the ownership or control of a service provider, or may be operated by the service provider or on behalf of the service provider. Connections 3221 and 3222 between telecommunication network 3210 and host computer 3230 may extend directly from core network 3214 to host computer 3230 or may go via an optional intermediate network 3220. Intermediate network 3220 may be one of, or a combination of more than one of, a public, private or hosted network; intermediate network 3220, if any, may be a backbone network or the Internet; in particular, intermediate network 3220 may comprise two or more sub-networks (not shown).

The communication system of FIG. 320 as a whole enables connectivity between the connected UEs 3291, 3292 and host computer 3230. The connectivity may be described as an Over-The-Top (OTT) connection 3250. Host computer 3230 and the connected UEs 3291, 3292 are configured to communicate data and/or signaling via OTT connection 3250, using access network 3211, core network 3214, any intermediate network 3220 and possible further infrastructure (not shown) as intermediaries. OTT connection 3250 may be transparent in the sense that the participating communication devices through which OTT connection 3250 passes are unaware of routing of uplink and downlink communications. Base station 3212 may not or need not be informed about the past routing of an incoming downlink communication with data originating from host computer 3230 to be forwarded, e.g., handed over, to a connected UE 3291. Similarly, base station 3212 need not be aware of the future routing of an outgoing uplink communication originating from the UE 3291 towards the host computer 3230.

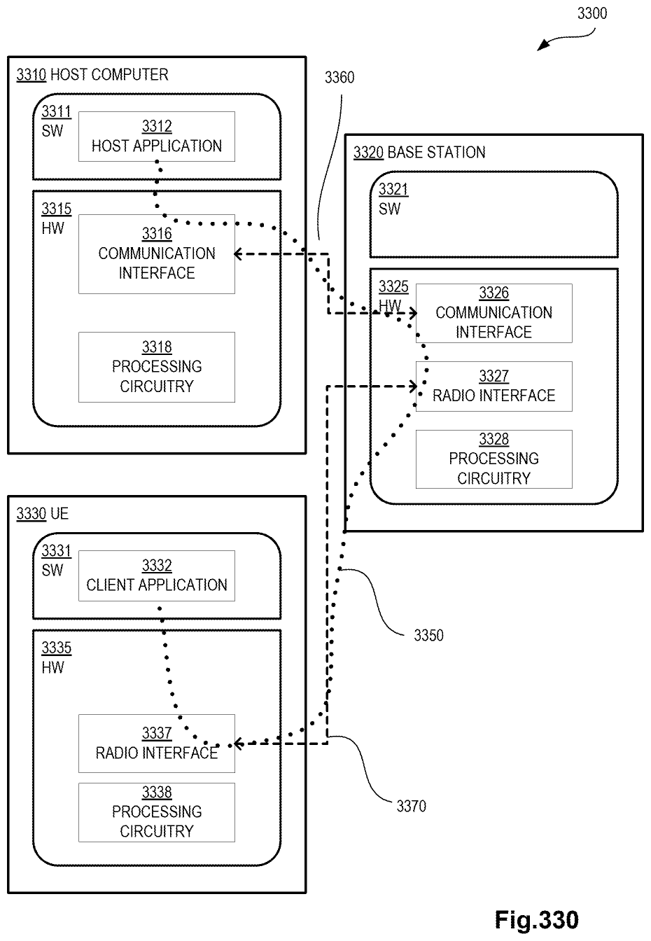

In relation to FIGS. 330-370 which are described next, it may be understood that the base station may be considered an example of the first network node 103a and/or the second network node 103b.

FIG. 330 illustrates a host computer communicating via a first network node 103a with a UE 101 over a partially wireless connection.

The UE 101 and the first network node 103a, e.g., a base station and host computer discussed in the preceding paragraphs will now be described with reference to FIG. 330. In communication system 3330, such as the communications system 100, host computer 3310 comprises hardware 3315 comprising communication interface 3316 configured to set up and maintain a wired or wireless connection with an interface of a different communication device of communication system 3300. Host computer 3310 further comprises processing circuitry 3318, which may have storage and/or processing capabilities. In particular, processing circuitry 3318 may comprise one or more programmable processors, ASICs, field programmable gate arrays or combinations of these (not shown) adapted to execute instructions. Host computer 3310 further comprises software 3311, which is stored in or accessible by host computer 3310 and executable by processing circuitry 3318. Software 3311 includes host application 3312. Host application 3312 may be operable to provide a service to a remote user, such as UE 3330 connecting via OTT connection 3350 terminating at UE 3330 and host computer 3310. In providing the service to the remote user, host application 3312 may provide user data which is transmitted using OTT connection 3350.

Communication system 3300 comprises the first network node 103a exemplified in FIG. 330 as a base station 3320 provided in a telecommunication system and comprising hardware 3325 enabling it to communicate with host computer 3310 and with UE 3330. Hardware 3325 may comprise communication interface 3326 for setting up and maintaining a wired or wireless connection with an interface of a different communication device of communication system 3300, as well as radio interface 3327 for setting up and maintaining at least wireless connection 3370 with the UE 101, exemplified in FIG. 330 as a UE 3330 located in a coverage area served by base station 3320. Communication interface 3326 may be configured to facilitate connection 3360 to host computer 3310. Connection 3360 may be direct or it may pass through a core network (not shown in FIG. 330) of the telecommunication system and/or through one or more intermediate networks outside the telecommunication system. In FIG. 330, hardware 3325 of base station 3320 comprises processing circuitry 3328, which may comprise one or more programmable processors, application-specific integrated circuits, field programmable gate arrays or combinations of these (not shown) adapted to execute instructions. Base station 3320 further has software 3321 stored internally or accessible via an external connection.

Communication system 3300 comprises the UE 3330 already referred to. It's hardware 3335 may include radio interface 3337 configured to set up and maintain wireless connection 3370 with a base station serving a coverage area in which UE 3330 is currently located. Hardware 3335 of UE 3330 comprises processing circuitry 3338, which may comprise one or more programmable processors, application-specific integrated circuits, field programmable gate arrays or combinations of these (not shown) adapted to execute instructions. UE 3330 comprises software 3331, which is stored in or accessible by UE 3330 and executable by processing circuitry 3338. Software 3331 comprises client application 3332. Client application 3332 may be operable to provide a service to a human or non-human user via UE 3330, with the support of host computer 3310. In host computer 3310, an executing host application 3312 may communicate with the executing client application 3332 via OTT connection 3350 terminating at UE 3330 and host computer 3310. In providing the service to the user, client application 3332 may receive request data from host application 3312 and provide user data in response to the request data. OTT connection 3350 may transfer both the request data and the user data. Client application 3332 may interact with the user to generate the user data that it provides.

It is noted that host computer 3310, base station 3320 and UE 3330 illustrated in FIG. 330 may be similar or identical to host computer 3230, one of base stations 3212a, 3212b, 3212c and one of UEs 3291, 3292 of FIG. 320, respectively. This is to say, the inner workings of these entities may be as shown in FIG. 330 and independently, the surrounding network topology may be that of FIG. 320.

In FIG. 330, OTT connection 3350 has been drawn abstractly to illustrate the communication between host computer 3310 and UE 3330 via base station 3320, without explicit reference to any intermediary devices and the precise routing of messages via these devices. Network infrastructure may determine the routing, which it may be configured to hide from UE 3330 or from the service provider operating host computer 3310, or both. While OTT connection 3350 is active, the network infrastructure may further take decisions by which it dynamically changes the routing, e.g., on the basis of load balancing consideration or reconfiguration of the network.

Wireless connection 3370 between UE 3330 and base station 3320 is in accordance with the present disclosure. The present disclosure improves the performance of OTT services provided to UE 3330 using OTT connection 3350, in which wireless connection 3370 forms the last segment. More precisely, the present disclosure may improve the spectrum efficiency, and latency, and thereby provide benefits such as reduced user waiting time, better responsiveness and extended battery lifetime.

A measurement procedure may be provided for the purpose of monitoring data rate, latency and other factors. There may further be optional network functionality for reconfiguring OTT connection 3350 between host computer 3310 and UE 3330, in response to variations in the measurement results. The measurement procedure and/or the network functionality for reconfiguring OTT connection 3350 may be implemented in software 3311 and hardware 3315 of host computer 3310 or in software 3331 and hardware 3335 of UE 3330, or both. Sensors (not shown) may be deployed in or in association with communication devices through which OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of OTT connection 3350 may include message format, retransmission settings, preferred routing etc.; the reconfiguring need not affect base station 3320, and it may be unknown or imperceptible to base station 3320. Such procedures and functionalities may be known and practiced in the art. Measurements may involve proprietary UE signaling facilitating host computer 3310's measurements of throughput, propagation times, latency and the like. The measurements may be implemented in that software 3311 and 3331 causes messages to be transmitted, in particular empty or ‘dummy’ messages, using OTT connection 3350 while it monitors propagation times, errors etc.

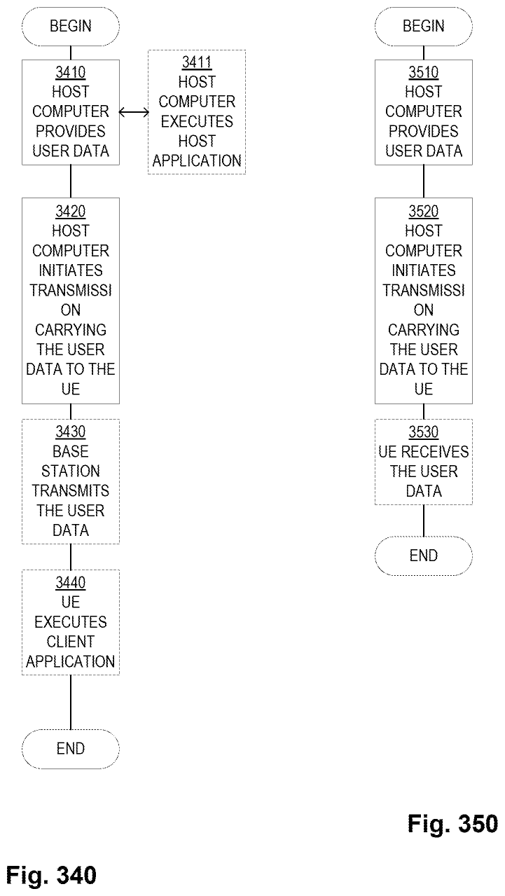

FIG. 340 illustrates methods implemented in a communication system including a host computer, a base station and a user equipment. FIG. 340 is a flowchart illustrating a method implemented in a communication system. The communication system includes a host computer, a base station and a UE which may be those described with reference to FIG. 320 and FIG. 330. For simplicity, only drawing references to FIG. 340 will be included in this section. In step 3410, the host computer provides user data. In substep 3411 (which may be optional) of step 3410, the host computer provides the user data by executing a host application. In step 3420, the host computer initiates a transmission carrying the user data to the UE. In step 3430 (which may be optional), the base station transmits to the UE the user data which was carried in the transmission that the host computer initiated. In step 3440 (which may also be optional), the UE executes a client application associated with the host application executed by the host computer.

FIG. 350 illustrates methods implemented in a communication system comprising a host computer, a base station and a user equipment. FIG. 350 is a flowchart illustrating a method implemented in a communication system. The communication system includes a host computer, a base station and a UE which may be those described with reference to FIG. 320 and FIG. 330. For simplicity, only drawing references to FIG. 350 will be included in this section. In step 3510 of the method, the host computer provides user data. In an optional substep (not shown) the host computer provides the user data by executing a host application. In step 3520, the host computer initiates a transmission carrying the user data to the UE. The transmission may pass via the base station. In step 3530 (which may be optional), the UE receives the user data carried in the transmission.

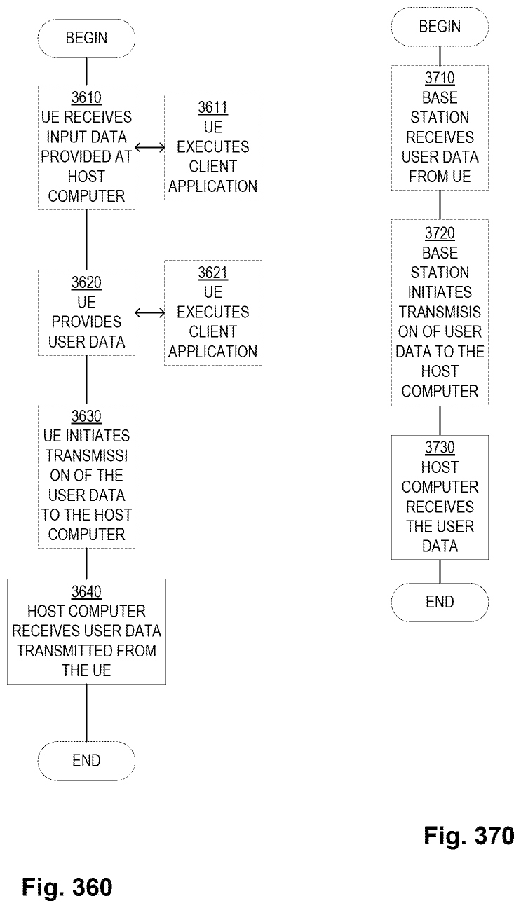

FIG. 360 illustrates methods implemented in a communication system comprising a host computer, a base station and a user equipment. FIG. 360 is a flowchart illustrating a method implemented in a communication system. The communication system includes a host computer, a base station and a UE which may be those described with reference to FIG. 320 and FIG. 330. For simplicity, only drawing references to FIG. 360 will be comprised in this section. In step 3610 (which may be optional), the UE 101 receives input data provided by the host computer. Additionally or alternatively, in step 3620, the UE 101 provides user data. In substep 3621 (which may be optional) of step 3620, the UE 101 provides the user data by executing a client application. In substep 3611 (which may be optional) of step 3610, the UE 101 executes a client application which provides the user data in reaction to the received input data provided by the host computer. In providing the user data, the executed client application may further consider user input received from the user. Regardless of the specific manner in which the user data was provided, the UE 101 initiates, in substep 3630 (which may be optional), transmission of the user data to the host computer. In step 3640 of the method, the host computer receives the user data transmitted from the UE 101.

FIG. 370 illustrates methods implemented in a communication system including a host computer, a base station and a user equipment. FIG. 370 is a flowchart illustrating a method implemented in a communication system. The communication system comprises a host computer, a base station and a UE which may be those described with reference to FIG. 320 and FIG. 330. For simplicity, only drawing references to FIG. 370 will be included in this section. In step 3710 (which may be optional), the base station receives user data from the UE. In step 3720 (which may be optional), the base station initiates transmission of the received user data to the host computer. In step 3730 (which may be optional), the host computer receives the user data carried in the transmission initiated by the base station.

Some embodiments may be summarized as follows:

A base station configured to communicate with a UE 101, the base station comprising a radio interface and processing circuitry configured to perform one or more of the actions described herein as performed by the first network node 103a

A communication system 100 comprising a host computer comprising:
processing circuitry configured to provide user data; and
a communication interface configured to forward the user data to a cellular network for transmission to a UE 101,
wherein the cellular network comprises a first network node 103a having a radio interface and processing circuitry, the base station's processing circuitry configured to perform one or more of the actions described herein as performed by the first network node 103a.

The communication system may further comprise the first network node 103a.

The communication system may comprise the UE 101. The UE 101 is configured to communicate with the first network node 103a.

The communication system, wherein:
the processing circuitry of the host computer is configured to execute a host application, thereby providing the user data; and
the UE 101 comprises processing circuitry configured to execute a client application associated with the host application.

A method implemented in a network node 103, comprising one or more of the actions described herein as performed by the first network node 103a.

A method implemented in a communication system 100 including a host computer, a base station and a UE 101, the method comprising:
at the host computer, providing user data; and
at the host computer, initiating a transmission carrying the user data to the UE 101 via a cellular network comprising the network node 103. The network node 103 performs one or more of the actions described herein as performed by the first network node 103a.

The method may comprise:
at the first network node 103a, transmitting the user data.

The user data may be provided at the host computer by executing a host application, and the method may comprise:
at the UE 101, executing a client application associated with the host application.

A UE 101 configured to communicate with a first network node 103a, the UE 101 comprising a radio interface and processing circuitry configured to perform one or more of the actions described herein as performed by the UE 101.

A communication system 100 comprising a host computer comprising:
processing circuitry configured to provide user data; and
a communication interface configured to forward user data to a cellular network for transmission to a UE 101,
the UE comprises a radio interface and processing circuitry, the UE's processing circuitry is configured to perform one or more of the actions described herein as performed by the UE 101.

The communication system may comprise the UE 101.

The communication system 100, wherein the cellular network comprises a first network node 103a configured to communicate with the UE 101.

The communication system 100, wherein:
the processing circuitry of the host computer is configured to execute a host application, thereby providing the user data; and
the UE's processing circuitry is configured to execute a client application associated with the host application.

A method implemented in a UE 101, comprising one or more of the actions described herein as performed by the UE 101.

A method implemented in a communication system 100 comprising a host computer, a first network node 103a and a UE 101, the method comprising:
at the host computer, providing user data; and
at the host computer, initiating a transmission carrying the user data to the UE 101 via a cellular network comprising the base station, wherein the UE 101 performs one or more of the actions described herein as performed by the UE 101.

The method may comprise:
at the UE 101, receiving the user data from the first network node 103a.

A UE 101 configured to communicate with a first network node 103a, the UE 101 comprising a radio interface and processing circuitry configured to perform one or more of the actions described herein as performed by the UE 101.

A communication system 100 comprising a host computer comprising:
a communication interface configured to receive user data originating from a transmission from a UE 101 to a first network node 103a,
the UE 101 comprises a radio interface and processing circuitry, the UE's processing circuitry is configured to: perform one or more of the actions described herein as performed by the UE 101.

The communication system 100 may comprise the UE 101.

The communication system 100 may comprise the first network node 103a. The network node 103 comprises a radio interface configured to communicate with the UE 101 and a communication interface configured to forward to the host computer the user data carried by a transmission from the UE 101 to the first network node 103a.

The communication system 100, wherein:
the processing circuitry of the host computer is configured to execute a host application; and
the UE's processing circuitry is configured to execute a client application associated with the host application, thereby providing the user data.

The communication system 100, wherein:
the processing circuitry of the host computer is configured to execute a host application, thereby providing request data; and
the UE's processing circuitry is configured to execute a client application associated with the host application, thereby providing the user data in response to the request data.

A method implemented in a UE 101, comprising one or more of the actions described herein as performed by the UE 101.

The method may comprise:
providing user data; and
forwarding the user data to a host computer via the transmission to the first network node 103a.

A method implemented in a communication system 100 comprising a host computer, a first network node 103a and a UE 101, the method comprising:
at the host computer, receiving user data transmitted to the first network node 103a from the UE 101, wherein the UE 101 performs one or more of the actions described herein as performed by the UE 101.

The method may comprise:
at the UE 101, providing the user data to the first network node 103a.

The method may comprise:
at the UE 101, executing a client application, thereby providing the user data to be transmitted; and
at the host computer, executing a host application associated with the client application.

The method may comprise:
at the UE 101, executing a client application; and
at the UE 101, receiving input data to the client application, the input data being provided at the host computer by executing a host application associated with the client application,
the user data to be transmitted is provided by the client application in response to the input data.

A network node 103 configured to communicate with a UE 101, the first network node 103a comprising a radio interface and processing circuitry configured to perform one or more of the actions described herein as performed by the first network node 103a.

A communication system 100 comprising a host computer comprising a communication interface configured to receive user data originating from a transmission from a UE 101 to a base station. The first network node 103a comprises a radio interface and processing circuitry, the base station's processing circuitry configured to perform one or more of the actions described herein as performed by the first network node 103a.

The communication system 100 may comprise the first network node 103a.

The communication system 100 may comprise the UE 101. The UE 101 is configured to communicate with the first network node 103a.

The communication system 100 wherein:
the processing circuitry of the host computer is configured to execute a host application;
the UE 101 is configured to execute a client application associated with the host application, thereby providing the user data to be received by the host computer.

A method implemented in a first network node 103a, comprising one or more of the actions described herein as performed by any of the first network node 103a.

A method implemented in a communication system including a host computer, a network node 103 and a UE 101, the method comprising:
at the host computer, receiving, from the first network node 103a, user data originating from a transmission which the first network node 103a has received from the UE 101, wherein the UE 101 performs one or more of the actions described herein as performed by the UE 101.

The method may comprise:
at the first network node 103a, receiving the user data from the UE 101.

The method may comprise:
at the first network node 103a, initiating a transmission of the received user data to the host computer.

The present disclosure relate to selection of target cell at conditional handover.

The present disclosure comprises a method for the UE 101 to select the target cell at conditional handover in the case when several cells fulfil the criterion configured by the network. The method comprises at least one of the following:
Selecting the cell based on multiple triggering quantities.
Selecting the cell based on the cell selection/cell reselection criterion.
Selection the cell based on UE implementation.
Selecting the cell based on highest delta of any of the methods above, e.g. highest increase of RSRP, highest increase of RSRQ.
Selecting the cell based on timing. The cell that first fulfilled the conditions is chosen.
Selecting the cell with highest trigger quantity;
Selecting the cell with highest “selection quantity”, where that is configurable;
Selecting the cell with highest number of good #beams”;
Selecting the cell with highest “selection quantity”, where that is based on a pre-defined rule;
Selecting the target cell base on the greatest margin to the CHO execution trigger condition. Note that different potential target cells may have different execution trigger conditions.
Selecting the target cell based on a combination of the improvement speed, i.e. the trigger quantity derivative, and the margin to the CHO execution trigger condition. The rationale is that a cell with a high derivative may be expected to “overtake” and soon become better than another cell with a lower derivative, even if the other cell currently has slightly better/higher absolute trigger quantity (e.g. RSRP) value. If the measurement interval is the same for all potential target cells, which can be expected at least for potential target cells on the same carrier frequency, the “delta” of a trigger quantity (e.g. RSRP or RSRQ) can be a measure of the trigger quantity derivative. If the measurement interval differs, then the trigger quantity can be calculated as the delta divided by the measurement interval, possibly averaged, using linear or exponential averaging, over multiple measurement intervals.
Selecting the target cell based on a combination of the improvement speed, i.e. the trigger quantity derivative, and the value of the trigger quantity. I.e. this may be similar to the preceding criterion, but without comparing the trigger quantity value with the CHO execution trigger condition.
Selecting the cell based on a combination of any of the methods listed herein, e.g. a combination of priority and cell selection/cell reselection criterion.
Another combination of selection criterion could be a combination of frequency priorities and margin to the CHO trigger condition or a combination of frequency priorities and the value of the trigger quantity. For instance, a UE 101 may be configured to prioritize potential target cells on frequency F1 over potential target cells on frequency F2, unless the potential target cell on F2 has a margin to its CHO trigger condition that is an offset greater than the corresponding margin of the potential target cell on F1.

There may be many possibilities to select the target cell in case multiple cells fulfil the conditions at conditional handover and with this invention more options are covered. Here are some examples of how the new criterion for selection, compared to prior art, may provide benefits.

For example, the prior art mentions the selection based on a fixed quantity e.g. RSRP or RSRQ or SINR. However, if it is assumed that the trigger condition is similar to reportConfig events, like A1, A2, . . . , A6 events, a single trigger quantity may be configured. So, if RSRP is standardized as that fixed quantity, the selection of cell if multiple shall be done based on that quantity regardless which trigger quantity is used. The first network node 103a may decide to use RSRQ, for example, but the UE 101 would have to do the selection based on RSRP. It is worth noting that RSRP might not even be available. Hence, having a configurable “selection quantity” is a much better solution. The first network node 103a may use RSRP as trigger quantity for the conditional handover/mobility, and, indicate to the UE 101 to perform selection based on RSRQ via an explicit configurable. But it may also apply other strategies where both trigger and selection are based on RSRQ. That also works for the variant where the selection quantity is the same as the trigger quantity. By doing that, it is ensured that measurements for the selection quantity are available.

The UE 101 may base the selection on a selection quantity based on a pre-defined rule such as:
Use RSRP as selection quantity if available i.e. if UE 101 has RSRP measurements for the triggered cells so it may choose the one with highest RSRP; or
Else, the UE 101 may use RSRQ as selection quantity if available and if RSRP is not available. That may occur if for the monitored cells, the UE 101 is not configured to perform RSRP measurements.
Else, the UE 101 may use SINR;

Tt may be assumed that there are multiple cells triggering the condition e.g. based on a single cell based quantity, like RSRP e.g. cell-A and cell-B have an RSRP difference with PCell higher than a threshold, with cell-A having slightly higher RSRP difference than cell-B. According to the prior art, the UE would select cell-A. However, especially in NR where a cell may be comprised of multiple beams, cell-A may have a higher number of good beams than cell-B e.g. cell-A has 4 good beams while cell-B has a single good beam. Hence, the selection only based on RSRP may not be the best alternative, as cell-B could be a much more reliable and robust target candidate. Hence, basing the selection on the cell having the highest number of good beams is a better strategy.

Generally, all terms used herein are to be interpreted according to their ordinary meaning in the relevant technical field, unless a different meaning is clearly given and/or is implied from the context in which it is used. All references to a/an/the element, apparatus, component, means, step, etc. are to be interpreted openly as referring to at least one instance of the element, apparatus, component, means, step, etc., unless explicitly stated otherwise. The steps of any methods disclosed herein do not have to be performed in the exact order disclosed, unless a step is explicitly described as following or preceding another step and/or where it is implicit that a step must follow or precede another step.

Any feature of any of the embodiments disclosed herein may be applied to any other embodiment, wherever appropriate. Likewise, any advantage of any of the embodiments may apply to any other embodiments, and vice versa. Other objectives, features and advantages of the enclosed embodiments will be apparent from the following description.

In general, the usage of “first”, “second”, “third”, “fourth”, and/or “fifth” herein may be understood to be an arbitrary way to denote different elements or entities, and may be understood to not confer a cumulative or chronological character to the nouns they modify, unless otherwise noted, based on context.

It should be noted that the examples herein are not mutually exclusive. Components from one embodiment may be tacitly assumed to be present in another embodiment and it will be obvious to a person skilled in the art how those components may be used in the other exemplary embodiments

The embodiments herein are not limited to the above described embodiments. Various alternatives, modifications and equivalents may be used. Therefore, the above embodiments should not be taken as limiting the scope of the embodiments. A feature from one embodiment may be combined with one or more features of any other embodiment.

The term “at least one of A and B” should be understood to mean “only A, only B, or both A and B.”, where A and B are any parameter, number, indication used herein etc.

It should be emphasized that the term “comprises/comprising” when used in this specification is taken to specify the presence of stated features, integers, steps or components, but does not preclude the presence or addition of one or more other features, integers, steps, components or groups thereof. It should also be noted that the words “a” or “an” preceding an element do not exclude the presence of a plurality of such elements.

The term “configured to” used herein may also be referred to as “arranged to”, “adapted to”, “capable of” or “operative to”.

It should also be emphasised that the steps of the methods maybe performed in another order than the order in which they appear herein.

1. A method performed by a User Equipment, UE, for initiating handover of the UE from a source cell to a target cell, the method comprising:
obtaining information indicating the handover criterion from a first network node, wherein the handover criterion is a conditional handover criterion for multiple candidate target cells,
determining that more than one candidate target cell fulfils the handover criterion;
monitoring multiple triggering quantities in parallel,
selecting, based on at least one parameter, a target cell from multiple candidate target cells, wherein each candidate target cell of the multiple candidate target cells fulfills the handover criterion, wherein the at least one parameter is preconfigured in the UE, hardcoded in the UE or obtained from a first network node, wherein the at least one parameter indicates that the target cell is to be selected based on the multiple triggering quantities, and wherein the target cell is selected based on a pre-defined arbitrary triggering quantity; and
initiating handover of the UE from the source cell to the selected target cell.

2. The method according to claim 1, further comprising:
obtaining information indicating the at least one parameter from a first network node.

3. (canceled)

4. The method according to claim 1, wherein each candidate target cell of the multiple candidate target cells has one or more associated parameter instance(s) of each of the at least one parameter, and wherein the UE selects the target cell based on comparing values of the respective parameter(s) instances associated with the respective candidate target cell.

5. The method according to claim 4, wherein the UE selects as the target cell the candidate target cell out of the multiple candidate target cells having a predetermined value of the associated parameter instance of the at least one parameter.

6. (canceled)

7. The method according to claim 1, wherein the at least one parameter indicates that the target cell is to be selected based on at least one of:
a) One or multiple triggering quantities; and/or
b) Cell selection/cell reselection criteria; and/or
c) UE implementation; and/or
d) Highest delta of at least one of:
i. a strongest Reference Signal Received Power, RSRP, value; and/or
ii. a strongest Reference Signal Received Quality, RSRQ, value; and/or
iii. a strongest Signal to Interference & Noise Ratio, SINR, value; and/or
iv. a highest priority; and/or
v. allocated Random Access Channel, RACH, resources which are first occurring in time; and/or
vi. a cell in which the UE performed latest measurement; and/or
vii. an intra-frequency; and/or
viii. an inter-frequency; and/or
ix. fulfilled a condition based on a combination of any of i-viii
e) Timing; and/or
f) The cell with highest trigger quantity; and/or
g) The cell with highest selection quantity, where that is configurable; and/or
h) The cell with highest number of good beams; and/or
i) The cell with highest selection quantity, where that is based on a pre-defined rule; and/or
j) The greatest margin to a Conditional Handover, CHO, execution trigger condition; and/or
k) A combination of an improvement speed and a margin to the CHO execution trigger condition; and/or
l) A combination of the improvement speed and the value of the trigger quantity; and/or
m) A combination of priority and at least one of cell selection and cell reselection criteria; and/or
n) A strongest RSRP value; and/or
o) A strongest RSRQ value; and/or
p) A strongest SINR value; and/or
q) A highest priority; and/or
r) Allocated RACH resources which are first occurring in time; and/or
s) A cell in which the UE performed latest measurement; and/or
t) An intra-frequency; and/or
u) An inter-frequency; and/or
v) A combination of frequency priorities and margin to the CHO trigger condition; and/or
w) A combination of frequency priorities and the value of the trigger quantity; and/or
x) combination of any of a)-w).

8. The method according to claim 7, wherein the information indicating the at least one parameter is comprised in an RRCConnectionReconfiguration message or in a mobilityControlInfo information element, or an RRCReconfiguration message or in a ReconfigurationWithSync information element.

9. A method performed by a first network node for initiating handover of a User Equipment, UE, from a source cell to a target cell, the method comprising:
providing, to the UE, information indicating at least one parameter on which the UE should base its selection of target cell from multiple candidate target cells, wherein each candidate target cell of the multiple candidate target cells fulfills a handover criterion, wherein the handover criterion is a conditional handover condition for multiple candidate target cells, wherein the at least one parameter indicates that the target cell is to be selected based on multiple triggering quantities
providing information indicating the handover criterion to the UE.

10. The method according to claim 8, further comprising:
selecting the at least one parameter from a plurality of candidate parameters.

11. (canceled)

12. The method according to claim 10, wherein the information indicating the at least one parameter is comprised in an RRCConnectionReconfiguration message or in a mobilityControlInfo information element, or an RRCReconfiguration message or in a ReconfigurationWithSync information element.

13. A User Equipment, UE, for initiating handover of the UE from a source cell to a target cell, the UE being adapted to:
obtain information indicating the handover criterion from a first network node (103a), wherein the handover criterion is a conditional handover criterion for multiple candidate target cells,
determine that more than one candidate target cell fulfils the handover criterion;
monitor multiple triggering quantities in parallel,
select, based on at least one parameter, a target cell from multiple candidate target cells, wherein each candidate target cell of the multiple candidate target cells fulfills the handover criterion, wherein the at least one parameter is preconfigured in the UE, hardcoded in the UE or obtained from a first network node, wherein the at least one parameter indicates that the target cell is to be selected based on the multiple triggering quantities, and wherein the target cell is selected based on a pre-defined arbitrary triggering quantity; and to
initiate handover of the UE (101) from the source cell (105a) to the selected target cell (105b).

14. The UE according to claim 13, adapted to:
obtain information indicating the at least one parameter from a first network node.

15. (canceled)

16. The UE according to claim 13, adapted to:
wherein each candidate target cell of the multiple candidate target cells has one or more associated parameter instance(s), and
wherein the UE selects the target cell based on comparing values of the respective parameter(s) instances associated with the respective candidate target cell.

17. The UE according to claim 16, wherein the UE is adapted to select as the target cell the candidate target cell out of the multiple candidate target cells having a predetermined value of the associated parameter instance of the at least one parameter.

18. (canceled)

19. The method according to claim 13, wherein the at least one parameter indicates that the target cell is to be selected based on at least one of:
a) One or multiple triggering quantities; and/or
b) Cell selection/cell reselection criteria; and/or
c) UE implementation; and/or
d) Highest delta of at least one of:
i. a strongest Reference Signal Received Power, RSRP, value; and/or
ii. a strongest Reference Signal Received Quality, RSRQ, value; and/or
iii. a strongest Signal to Interference & Noise Ratio, SINR, value; and/or
iv. a highest priority; and/or
v. allocated Random Access Channel, RACH, resources which are first occurring in time; and/or
vi. a cell in which the UE performed latest measurement; and/or
vii. an intra-frequency; and/or
viii. an inter-frequency; and/or
ix. fulfilled a condition based on a combination of any of i-viii
e) Timing; and/or
f) The cell with highest trigger quantity; and/or
g) The cell with highest selection quantity, where that is configurable; and/or
h) cell with highest number of good beams; and/or
i) The cell with highest selection quantity, where that is based on a pre-defined rule; and/or
j) The greatest margin to a Conditional Handover, CHO, execution trigger condition; and/or
k) A combination of an improvement speed and a margin to the CHO execution trigger condition; and/or
l) A combination of the improvement speed and the value of the trigger quantity; and/or
m) A combination of priority and at least one of cell selection and cell reselection criteria; and/or
n) A strongest RSRP value; and/or
o) A strongest RSRQ value; and/or
p) A strongest SINR value; and/or
q) A highest priority; and/or
r) Allocated RACH resources which are first occurring in time; and/or
s) A cell in which the UE performed latest measurement; and/or
t) An intra-frequency; and/or
u) An inter-frequency; and/or
v) A combination of frequency priorities and margin to the CHO trigger condition; and/or
w) A combination of frequency priorities and the value of the trigger quantity; and/or
x) combination of any of a)-w)

20. The UE according to claim 13, wherein the information indicating the parameter comprised in an RRCConnectionReconfiguration message or a mobilityControlInfo information element, or an RRCReconfiguration message or in a ReconfigurationWithSync information element.

21. A first network node for initiating handover of the UE from a source cell to a target cell, the first network node being adapted to:
provide information indicating the handover criterion to the UE; and
provide, to a User Equipment, UE, information indicating at least one parameter on which the UE should base its selection of target cell from multiple candidate target cells, wherein each candidate target cell of the multiple candidate target cells fulfills a handover criterion, wherein the handover criterion is a conditional handover criterion for multiple candidate target cells, wherein the at least one parameter indicates that the target cell (105b) is to be selected based on multiple triggering quantities.

22. The first network node according to claim 21, adapted to:
select the at least one parameter from a plurality of candidate parameters.

23. (canceled)

24. The first network node according to claim 21, wherein the information indicating the parameter comprised in an RRCConnectionReconfiguration message or in a mobilityControlInfo information element, or an RRCReconfiguration message or in a ReconfigurationWithSync information element.

25. A computer program comprising instructions which, when executed on at least one processor, cause the at least one processor to carry out the method according to claim 1.

26. A carrier comprising the computer program of claim 25, wherein the carrier is one of an electronic signal, optical signal, radio signal or computer readable storage medium.
